(19) United States
(12) Patent Application Publication
(10) Pub. No.: US 2025/0156822 A1
(43) Pub. Date: May 15, 2025

(54) COMMODITY DELIVERY CONTRACT WITH AUTOMATED ESCROW CONTRACT

(71) Applicant: Wells Fargo Bank, N.A., San Francisco, CA (US)

(72) Inventor: Marc Ward, San Francisco, CA (US)

(73) Assignee: Wells Fargo Bank, N.A., San Francisco, CA (US)

(21) Appl. No.: 17/827,387

(22) Filed: May 27, 2022

Related U.S. Application Data
(60) Provisional application No. 63/256,495, filed on Oct. 15, 2021.

(51) Int. Cl. G06Q 20/06

(52) U.S. Cl. CPC G06Q 20/06

(57) ABSTRACT

Systems, methods and computer-readable storage media utilized to create and perform an automated escrow contract on a distributed ledger network. One method comprises creating, by a first user of the distributed ledger network, the automated escrow contract on the distributed ledger network by providing contract information specifying an offer. The method further comprises accepting, by a second user of the distributed ledger network, the offer by providing a payment amount of a digital currency unit to the automated escrow contract on the distributed ledger network. The method further comprises confirming, by the second user, that the automated escrow contract has been completed. The method further comprises releasing, by the automated escrow contract, the payment amount of the digital currency unit from the second user to the first user.

### CROSS REFERENCE TO RELATED APPLICATION

This application claims the benefit of and priority to U.S. Provisional Patent Application No. 63/256,495, entitled “COMMODITY DELIVERY CONTRACT AND AUTOMATED ESCROW CONTRACT,” filed Oct. 15, 2021, which is hereby incorporated by reference in its entirety.

### BACKGROUND

The present disclosure relates generally to the field of distributed ledger technology (DLT). In a computer networked environment such as the internet, users and entities such as people or companies exchange assets on distributed ledger networks.

### SUMMARY

Some arrangements relate to a method for creating and performing an automated escrow contract on a distributed ledger network. The method comprises creating, by a first user of the distributed ledger network, the automated escrow contract on the distributed ledger network by providing contract information specifying an offer. The method further comprises accepting, by a second user of the distributed ledger network, the offer by providing a payment amount of a digital currency unit to the automated escrow contract on the distributed ledger network. The method further comprises confirming, by the second user, that the automated escrow contract has been completed. The method further comprises releasing, by the automated escrow contract, the payment amount of the digital currency unit from the second user to the first user.

Some arrangements relate to a system comprising a distributed ledger network and at least one processing circuits. The at least one processing circuit is configured to create, by a first user of the distributed ledger network, an automated escrow contract on the distributed ledger network by providing contract information specifying an offer. The at least one processing circuit is further configured to accept, by a second user of the distributed ledger network, the offer by providing a payment amount of a digital currency unit to the automated escrow contract on the distributed ledger network. The at least one processing circuit is further configured to confirm, by the second user, that the automated escrow contract has been completed. The at least one processing circuit is further configured to release, by the automated escrow contract, the payment amount of the digital currency unit from the second user to the first user.

Some arrangements relate to one or more computer-readable storage media having instructions stored thereon that, when executed by at least one processing circuit, cause the at least one processing circuit to create, by a first user of a distributed ledger network, an automated escrow contract on the distributed ledger network by providing contract information specifying an offer. The instructions further cause the at least one processing circuit to accept, by a second user of the distributed ledger network, the offer by providing a payment amount of a digital currency unit to the automated escrow contract on the distributed ledger network. The instructions further cause the at least one processing circuit to confirm, by the second user, that the automated escrow contract has been completed. The instructions further cause the at least one processing circuit to release, by the automated escrow contract, the payment amount of the digital currency unit from the second user to the first user.

These and other features, together with the organization and manner of operation thereof, will become apparent from the following detailed description when taken in conjunction with the accompanying drawings.

### BRIEF DESCRIPTION OF THE DRAWINGS

FIG. 1A is a block diagram depicting an example of a system for performing various transactions on a distributed ledger network, according to some arrangements.

FIG. 1B is a block diagram depicting an example of a system for performing various transactions on a distributed ledger network, according to some arrangements.

FIG. 2A is a block diagram depicting an example of a distributed ledger node, according to some arrangements.

FIG. 2B is a block diagram depicting an example of a distributed ledger node, according to some arrangements.

FIG. 3 is a block diagram depicting an example of various parties to an automated escrow contract within a distributed ledger network, according to some arrangements.

FIG. 4 is a flowchart for a method of performing an automated escrow contract within a distributed ledger network, according to some arrangements.

FIG. 5 is a block diagram depicting an example of various parties to a commodity delivery contract within a distributed ledger network, according to some arrangements.

FIG. 6 is a flowchart for a method of performing a commodity delivery contract within a distributed ledger network, according to some arrangements.

FIG. 7 is a block diagram showing a user ecosystem on a distributed ledger network, according to some arrangements.

FIG. 8 is a block diagram showing another user ecosystem on a distributed ledger network, according to some arrangements.

FIG. 9 is an example accounts view showing a plurality of user account information windows, according to some arrangements.

FIG. 10 is an example chart of a plurality of digital currency unit account values at an initial time state, according to some arrangements.

FIG. 11 is a state diagram of a plurality of actions occurring at a first action time state, according to some arrangements.

FIGS. 12A and 12B are example charts of a plurality of digital currency unit account value updates occurring at the first action time state, according to some arrangements.

FIG. 13 is an example chart of a plurality of digital currency unit account value results at the first action time state, according to some arrangements.

FIG. 14 is a state diagram of a plurality of actions occurring at a second action time state, according to some arrangements.

FIGS. 15A and 15B are example charts of a plurality of digital currency unit account value updates occurring at the second action time state, according to some arrangements.

FIG. 16 is an example chart of a plurality of digital currency unit account value results at the second action time state, according to some arrangements.

FIG. 17 is a state diagram of a plurality of actions occurring at a third action time state, according to some arrangements.

FIGS. 18A and 18B are example charts of a plurality of digital currency unit account value updates occurring at the third action time state, according to some arrangements.

FIG. 19 is an example chart of a plurality of digital currency unit account value results at the second action time state, according to some arrangements.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Described herein are systems and methods for creating and performing automated escrow contracts, commodity delivery contracts, and transferring a variety of digital currency units via a distributed ledger network. The automated escrow contracts are configured to enable two individuals to complete a payment or transfer goods/services without a direct interaction with an intermediary. Each participant may act as their own escrow agent. Furthermore, when coupled with a forward contract, the ability to transfer payment for goods/services that will be provided at a future date enables these automated escrow contracts to be transferable, divisible and transferred without an intermediary.

The automated escrow contract described herein is a process enabled by code coupled with a distributed ledger network. The automated escrow contract is a smart contract whose code can be viewed by both the buyer and seller, thereby creating a transparent means of communication. The cryptography of the distributed ledger network enables individuals to transfer units of currency into a coded contract (e.g., via the exchange of key pairs representative of the units of currency), thereby preventing double spending of their currency units or transferring payment beyond their limits of currency within their accounts. The automated escrow contract allows for sellers to receive payment in the automated escrow contract before private information is released to the buyer. The buyer is protected because they are able to withdraw their payment at any time prior to acceptance by the seller, and the seller is protected because they can verify that the payment is ready for transfer into their account. Further, after the completion of the contract, both participants may leave a comment and review to be published on the distributed ledger (e.g., the blockchain).

Accordingly, the automated escrow contract is unique because it beneficially enables two disconnected individuals to transfer payment or conduct various other transactions without an intermediary by essentially being their own escrow agents. The distributed ledger enables trust to be accomplished through code which is visible to multiple parties who desire to participate.

This may effectively remove the middle man, the traditional escrow agent, who has historically been responsible for temporarily holding contractual payments. Middlemen, such as escrow agents, generally create friction between and reduce the benefit to the contract counterparties. Beneficially, the systems and methods discussed herein replace the traditional escrow agent with a coded contract published on a distributed ledger. That is, the automated escrow contract enables individuals to participate in a trusted contract without an intermediary. The automated escrow contract further enables individuals to build their credit of completion over time through the ability for the participants to review and log their experiences.

The commodity delivery contract described herein is similar to and builds upon the automated escrow contract by further including a contract “Ensurer” and a contract “Insurer.” The contract “Ensurer” is responsible for closing the contract to ensure the commodity is delivered as promised. The contract “Insurer” provides either payment or commodity as collateral to insure the delivery of the commodity to the consumer. The producer is then responsible for producing the commodity and receives payment from the commodity delivery contract at scheduled points in time or after pre-determined gates are met. Accordingly, the commodity delivery contract makes automated escrow contracts for the future production of a commodity possible by anyone on the network with currency to participate.

Traditionally, commodities receive their exchange rates from various third parties (e.g., CME Group) which never deliver the underlying commodity, such that producers and consumers are at the mercy of these centralized price tools. Given the third parties are separate from the production and delivery of the commodities, the commodity deliver contracts described herein may effectively replace their function.

In some instances, the systems and methods described herein may utilize digital currency units issued by an asset issuer computing device as deferred liabilities, which may also be referred to as “crypto chips.” The deferred-liability accounting of the crypto chips may result in the crypto chips being non-taxable as income upon issuance. Additionally, the crypto chips may not be classified as property, and may thus provide members with the ability to defer income until they redeem the digital currency units for the underlying property.

Accordingly, due to the tax advantages and exchangeability of the crypto chips with other types of assets on the distributed ledger network, members may be motivated to mine crypto chips (e.g., with their excess computing power). For example, mining crypto chips may involve mining the underlying cryptocurrencies associated with a given crypto chip directly to a public address associated with the asset issuer computing device in exchange for crypto chips.

Additionally, the systems and methods described herein may implement digital currency units that create a “bill of credit” or a “promise to pay” the transactions fees collected on transactions within the distributed ledger network in order to realize Metcalfe's Law for the distributed ledger network described herein. Traditional distributed ledger networks have not realized Metcalfe's Law. For example, traditional distributed ledger networks, which enable distributed individuals to intercommunicate, have been priced in a “repeating promise to pay a promise to pay” (e.g., repeating promises). If one takes the limit as time goes to zero, the number of repeating promises needed to acquire Asset Money does not converge given repeating promises do not exist at time equals 0. Communication and transactions always settle at time equals 0 enabling this simple proof to show that Federal Reserve Notes (e.g., repeating promises) or its digital claim counterpart (“USD”) cannot be used to value a distributed ledger network according to Metcalfe's Law.

However, when transactions occur in Dollars of Silver and Dollars of Gold (Legal Tender Asset Money) and the fee is distributed to owners of a finite, fungible, and divisible cryptocurrency with a portion widely distributed at launch, then these digital currency units may be referred to as Cryptographic Return of Asset Money (CRAM) herein and initiate Metcalfe's Law. The CRAM may act as a promise to pay the transaction fees (e.g., from the asset issuer to the owner) that are denominated in Asset Money due to each Automated Escrow Contract and Commodity Delivery Contract that charges a fee in the currency (or currencies) used in that transaction. This fee is then distributed automatically, via code, to the owners of CRAM. In some instances, the currencies available for use in this network are digital claims for Legal Tender Asset Money. Asset Money is described as an object that, when held by an individual, has no corresponding liability or debt. Given the ability to initiate Metcalfe's Law, the CRAM may provide a proxy for estimating the emotional desire of users to be in and own the transaction fees of the network. That is, in these instances, the CRAM may act as a Giffen good (the exchange rates for it increase as demand increases for it), and more individuals will join the network to receive CRAM. Accordingly, CRAM may be used as an incentive to join the network and, once there, participants will conduct transactions, thereby increasing the number of interconnected people in the network and, per Metcalfe's Law, its value.

Further, the Automated Escrow Contracts and Commodity Delivery Contracts performed on the distributed ledger network generate transaction fees. Thus, the participants see a higher return (yield) on their CRAM in exogenous currencies as more transactions occur due to the increased individuals in the distributed ledger network. This higher return (yield) therefore results in an increased desire to obtain CRAM for its yield. In some embodiments, the yield of CRAM is not measured in a percentage, but a quantity of each of the other currencies it delivers over time. In these embodiments, CRAM must be and remain finite upon distribution to achieve these results. This ability to cryptographically seal the CRAM ledger and redirect the transactions fees denominated in Asset Money to the owners of the CRAM brings an increasing benefit to the owners of CRAM over time as more individuals join the distributed ledger network to receive their distribution of CRAM, buy CRAM, and conduct transactions.

Thus, CRAM allows the distributed ledger network described herein to realize Metcalfe's Law. Accordingly, as more individuals join the distributed ledger network, the ability for users of the distributed ledger network to share knowledge amongst one another arises. For example, in some embodiments, the described distributed ledger network that provides its transaction fees to owners of CRAM has a knowledge graph layered into the distributed ledger network. In these instances, the stored energy (Asset Money) in the distributed ledger network combined with knowledge provided by the graph establishes a Knowledge-Energy Network that will have a known increase in energy and a potential increase in knowledge with the addition of each new network participant. Further, participants of the distributed ledger network are incentivized to share or exchange their knowledge with the distributed ledger network to increase the exchange rates of the CRAM they own and/or to obtain additional units of CRAM.

As such, the systems and methods described above and herein provide a network with increasing knowledge and increasing energy through time with value denominated in CRAM. Accordingly, members may desire, transfer, and receive the digital currency units in this network because of the yield, utility, and knowledge they may provide.

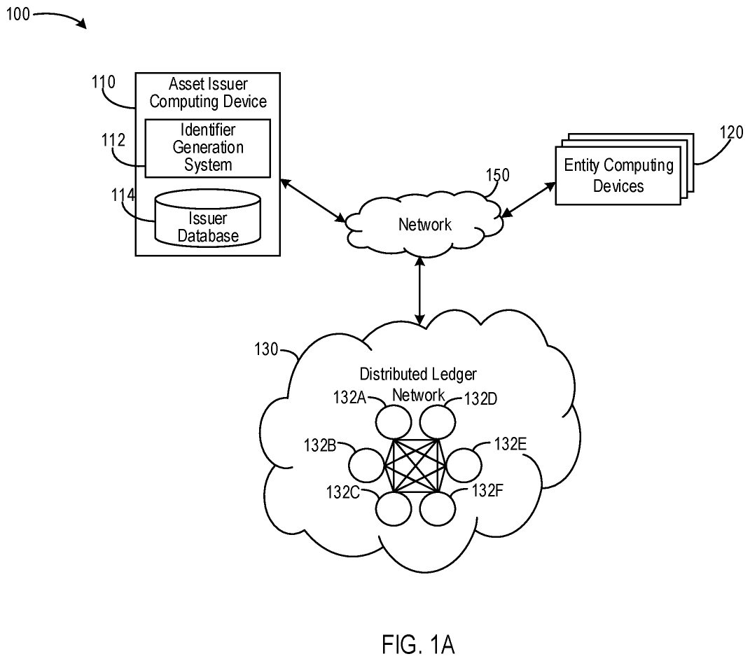

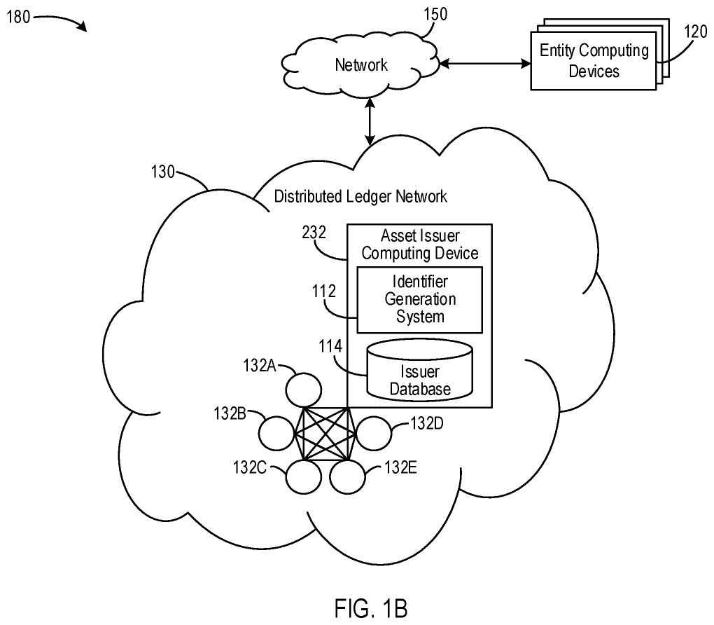

Referring now to FIG. 1A, a block diagram depicting an example of a system 100 for tracking assets on a distributed ledger network 130 is shown, according to some arrangements. The system 100 is shown to include an asset issuer computing device 110, an identifier generation system 112, an issuer database 114, one or more entity computing devices 120, a distributed ledger network 130, a plurality of distributed ledger nodes (e.g., 132A, 132B, 132C, 132D, 132E, 132F), and a network 150. The network 150 may include a local area network (LAN), wide area network (WAN), a telephone network, such as the Public Switched Telephone Network (PSTN), a wireless link, an intranet, the Internet, or combinations thereof. The system 100 can also include at least one data processing system or processing circuit, such as an asset issuer computing device 110. The asset issuer computing device 110 can communicate via the network 150, for example with entity computing devices 120, and/or with distributed ledger nodes on the distributed ledger network 130.

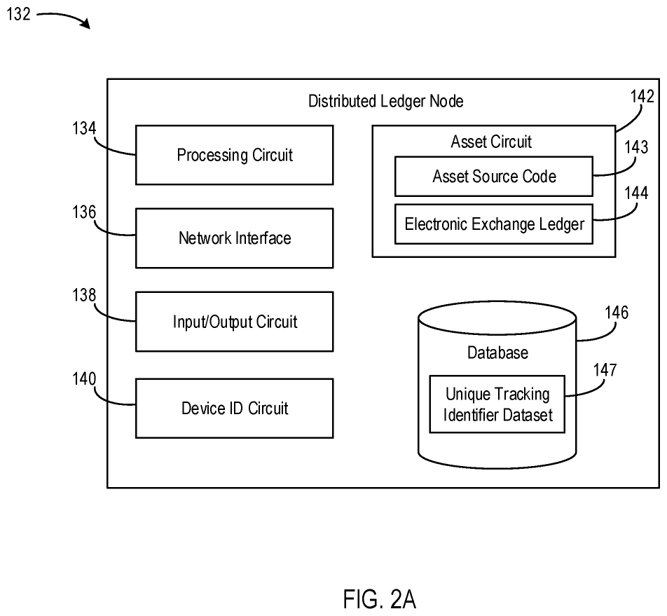

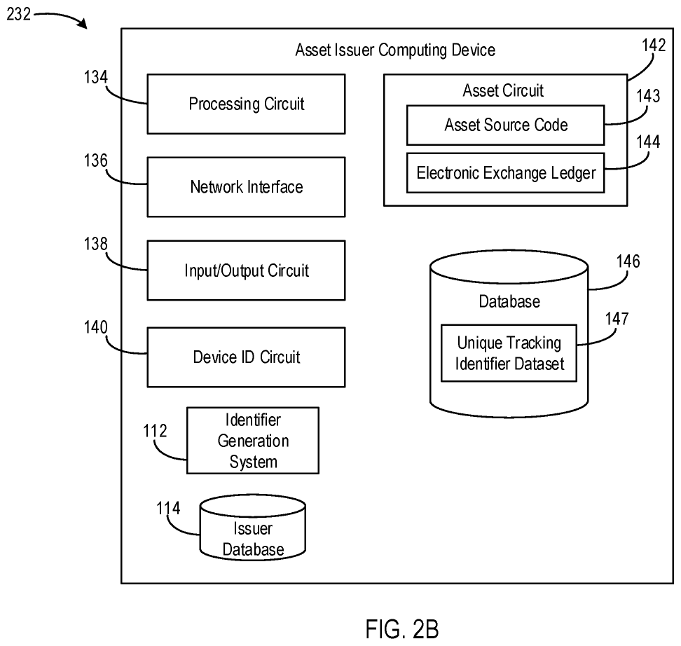

Referring to FIGS. 1A-2B, the one or more processing circuits can include a microprocessor, an application specific integrated circuit (ASIC), a field-programmable gate array (FPGA), and so on, or combinations thereof. A memory can include, but is not limited to, electronic, optical, magnetic, or any other storage or transmission device capable of providing processor with program instructions. Instructions can include code from any suitable computer programming language.

In some arrangements, the asset issuer computing device 110 can be executed on one or more processing circuits, such as those described below in detail with reference to FIG. 2B. In addition to the processing circuit, the asset issuer computing device 110 may include one or more databases (e.g., issuer database 114) configured to store data. The asset issuer computing device 110 may also include a generation system (e.g., identifier generation system 112) configured to receive data (e.g., requests) via the network 150 and provide data (e.g., unique tracking identifiers) from the asset issuer computing device 110 to any of the other system and devices on network 150.

The asset issuer computing device 110 may be communicably coupled to and configured to operate various distributed ledgers nodes on the distributed ledger network 130. That is, the asset issuer computing device 110 may have the role of issuing assets to and/or otherwise managing assets on the distributed ledger network 130. The asset issuer computing device 110 may further have the role of destroying assets in response to various commands. “Assets,” as used herein, may refer to digital representations of a plurality of different assets. For example, an asset could be a lending and/or trading document/contract, a financial exchange, a fiat currency, a payment card, a payment account, or any of assets associated with services carried out by a financial institution. Further, each asset that is issued by the asset issuer computing device 110 may include a unique tracking identifier such that the asset can be tracked whenever an exchange of an asset occurs (e.g., a smart contract is executed).

In some arrangements, the unique tracking identifier is generated by the identifier generation system 112. That is, the identifier generation system 112 may include one or more processing circuits that, when executed, can generate a unique tracking identifier associated with a specific asset. The identifier generation system 112 can retrieve data stored in the issuer database 114 that can be utilized to generate the unique tracking identifier. The data stored in the issuer database 114 may include payment account information associated with a plurality of clients of a financial institution, identifying information associated with the plurality of clients of the financial institution, asset information, and a plurality of financial information. Further, the data stored in the issuer database 114 may include personal information (e.g., names, addresses, phone numbers, and so on), authentication information (e.g., username/password combinations, device authentication tokens, security question answers, unique client identifiers, biometric data, geographic data, social media data, and so on), and financial information (e.g., token information, account numbers, account balances, available credit, credit history, exchange histories, and so on) relating to the various users and associated financial accounts. For example, asset information may include a list of asset types, a list of asset issuer identifiers, and any metadata associated with the asset (e.g., creation date, owner, last modified, and so on). In some arrangements the issuer database 114 may include a subset of databases such that the identifier generation system 112 can analyze each database to determine the appropriate information needed to generate the unique tracking identifier.

In various arrangements, assets can be described as tokens or tokenized assets. The asset issuer computing device 110 can also query, via the network 150, one or more distributed ledger nodes 132 for information associated with assets on the distributed ledger network 130. For example, the asset issuer computing device 110 can send commands (e.g., a request to track command, an asset update command, a metadata retrieval command, a unique tracking identifier retrieval command) to the distributed ledger network 130 such that one or more processing circuits (e.g., processing circuit 134 in FIG. 2A) of the one or more distributed ledger nodes can execute the command. In some examples, the command may receive a response indicating and/or providing data associated with the executed command on the distributed ledger network 130.

The identifier generation system 112 can further include a process for generating a unique tracking identifier. The unique tracking identifier can be a predetermined length (e.g., 16 bytes, 32 bytes, and so on) that can include a subset of identifiers. In various arrangements, the subset of identifiers can include an asset issuer identifier (e.g., ISO 9362 standard, Swift code, and so on), an asset type identifier (e.g., 1 byte, 4 bytes), and a unique identifier (e.g., IEFT RFC4122, Universally Unique identifier (UUID), Uniform Resource Identifier (URI), Cryptographic Hash, and so on).

In some arrangements, the unique tracking identifier could include other optional subsets of identifiers. For example, other subsets of identifiers could include asset creation date, geolocation data of the asset, asset owner. In other examples, the unique tracking identifier could include subset identifiers such as duration, biometric information, geolocation (or location), fraction or percentage to track fractional ownership of an asset. That is, the unique tracking identifier could include a subset identifier that identifies fractional ownership of a specific asset. For example, John Doe may have 50% ownership in the specific asset, and John Candy may have 50% ownership in the specific asset. Further, the unique tracking identifier could include a subset identifier that identifies the geolocation of a specific asset. For example, the unique tracking identifier may include latitude data, longitude data, and/or and other type of location or position data to determine the location of the specific asset. More, the unique tracking identifier could include a subset identifier that identifies biometric data of a specific asset. For example, the unique tracking identifier may include biological (e.g., fingerprint, iris/retina, hand geometry, facial geometry, DNA, etc.) and/or behavioral (e.g., gait, gesture, keystroke dynamics, speech pattern, foot movement pattern, etc.) characteristics that can distinguish one asset from another.

In various arrangements, the format of the unique tracking identifier can vary depending on the asset and/or application. For example and as shown above, the unique tracking identifier can be formatted such that the asset issuer identifier is first, asset type identifier is second, and unique identifier is third in the string. However, in another example, the unique tracking identifier could be formatted such that the unique identifier is first, asset type identifier is second, and asset issuer identifier is third.

One or more entity computing devices 120 may be user to perform various actions and/or access various types of data, some of which may be provide over network 150. An “entity” used herein may refer to a company with one or more individuals operating the entity computing devices 120, and interacting with resources or data via the entity computing devices 120. For example, in some instances, the entity computing devices 120 may be associated with entities managing various physical and/or virtual assets. In some instances, these entities may be third parties that are contracted or otherwise configured to hold various physical assets and/or virtual assets for selective distribution to users of the distributed ledger network 130. The entity computing devices 120 may be used to send data (e.g., exchange information) to the asset issuer computing device 110, or may be used to send updated tracking information to the distributed ledger network 130. The entity computing devices 120 can include one or more processors (e.g., any general purpose or special purpose processor), and include and/or be operably coupled to one or more transitory and/or non-transitory storage mediums and/or memory devices (e.g., any computer-readable storage media, such as a magnetic storage, optical storage, flash storage, RAM, and so on).

In various arrangements, entity computing devices 120 can be communicably and operatively coupled (e.g., over network 150) to distributed ledger network 130 and/or asset issuer computing device 110. The entity computing devices 120 can be configured to query the distributed ledger network 130 for information and store information in the distributed ledger network 130. In various arrangements, the distributed ledger network 130 includes various transitory and/or non-transitory storage mediums (e.g., the storage mediums may include but are not limited to magnetic storage, optical storage, flash storage, RAM, and so on). In some arrangements, there may be a plurality of distributed ledger networks that are communicably coupled to each other such that each node on each distributed ledger network can communicate with each other over network 150.

Entity computing devices 120 can be configured to communicate with any device or system shown in system 100 via the network 150. In some arrangements, the entity computing devices 120 can operate as a point-of-sale device such that each entity computing device can include a display, an input device and an application. The display may be used to present account information, exchange information, and the like to a client. The input device may be used to provide input to the entity computing devices 120 and to the asset issuer computing device 110 through the network 150. The input may relate to a financial institution service (e.g., loan request, credit requests, personal information, and so on) used to facilitate exchanges between the asset issuer computing device 110 and the client. The input device may include a keyboard, a mouse, a touchscreen, a biometric sensor (e.g., a fingerprint sensor), a microphone, a camera, a geographic location, and so on. The application may include program logic (e.g., stored executable instructions) configured to implement at least some of the functions described herein. The application may simply be a web browser (e.g., Internet Explorer®, Chrome®, Safari®, and so on) configured to receive and display web pages received from the distributed ledger network 130 and/or asset issuer computing device 110. In other arrangements, the application may include a dedicated application (e.g., a smartphone application), a text message interface, or another program suitable for communicating with the financial institution computing system 106 over the network.

The system 100 can also include a distributed ledger network 130 that can execute smart contracts and store a plurality of unique tracking identifiers associated with specific assets. The distributed ledger network 130 can include a plurality of nodes that are interconnected with one another to form a peer-to-peer network. As shown in FIG. 1A, the distributed ledger network 130 includes nodes 132A, 132B, 132C, 132D, 132E, 132F (collectively referred to herein as “nodes 132”) that are interconnected with one another to form the peer-to-peer network. Each of nodes 132 on the distributed ledger network include hardware elements, one or more processors (e.g., any general purpose or special purpose processor), and/or be operably coupled to one or more transitory and/or non-transitory storage mediums and/or memory devices (e.g., any computer-readable storage media, such as a magnetic storage, optical storage, flash storage, RAM, and so on). In some arrangements, each unique tracking identifier could be associated with a specific asset such that the specific asset can be tracked as it exchanged between parties (and as described in detail with reference to FIG. 2A).

Referring now to FIG. 1B, a block diagram depicting an example of a system 180 for tracking assets on a distributed ledger network 130 is shown, according to some arrangements. The system 180 includes the identifier generation system 112, the issuer database 114, the one or more entity computing devices 120, the distributed ledger network 130, the plurality of distributed ledger nodes (e.g., 132A, 132B, 132C, 132D, 132E), and a network 150.

However, as shown, in some arrangements, the distributed ledger network 130 includes an asset issuer computing device 232 (collectively referred to herein as “asset issuer node 232”) that can be interconnected with the distributed ledger nodes (e.g., 132A, 132B, 132C, 132D, 132E) to form a peer-to-peer network (e.g., distributed ledger network 130). Indeed, since the asset issuer node 232 is on the distributed ledger network 130, the asset issuer node 232 can perform operations (e.g., track assets, generate unique identifiers, and so on) on the distributed ledger network 130.

For example, instead of communicating over the network 150 for various transaction operations and related computing tasks, the asset issuer node 232 can track assets as it exchanged between parties (e.g., communicating with nodes 132) on the distributed ledger network 130. In some arrangements, the asset issuer node 232 and nodes 132 can be interconnected by any form or medium of digital data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks). Additional details relating to the functions of the distributed ledger network 130 and the asset issuer node 232 are provided herein with respect to FIG. 2B.

Referring now to FIG. 2A, a block diagram depicting an example of a distributed ledger node 132 of the distributed ledger network 130 in FIG. 1A is shown, according to some arrangements. That is, any of the nodes (e.g., 132A, 132B, 132C, 132D, 132E, 132F) in FIG. 1A may be a distributed ledger node 132 in FIG. 2A. While various circuits, interfaces, and logic with particular functionality are shown, it should be understood that the distributed ledger node 132 can include any number of circuits, interfaces, and logic for facilitating the functions described herein. For example, the activities of multiple circuits may be combined as a single circuit and implemented on a single processing circuit (e.g., processing circuit 134), as additional circuits with additional functionality are included.

The distributed ledger node 132 can be run or otherwise be executed on one or more processors of a computing device, such as those described below in detail with reference to FIG. 2A. In broad view, the distributed ledger node 132 can include a processing circuit 134, a network interface 136, an input/output circuit 138, a device ID circuit 140, an asset circuit 142, asset source code 143, an exchange ledger 144, a database 146, and a unique tracking identifier dataset 147. In some arrangements, the distributed ledger node 132 can include a processing circuit 134 composed of one or more processors and memory.

The distributed ledger node 132 can include a network interface 136 configured to establish a communication session with a computing device for sending and receiving data over the network 150 to the various other nodes and computing devices. Accordingly, the network interface 136 includes a cellular transceiver (supporting cellular standards), a global positioning system (GPS) transceiver (supporting GPS standards), a local wireless network transceiver (supporting 802.11X, ZigBee, Bluetooth, Wi-Fi, or the like), a wired network interface, a combination thereof (e.g., both a cellular transceiver, GPS transceiver, a Bluetooth transceiver, and so on), and/or the like. In some arrangements, the distributed ledger node 132 includes a plurality of network interfaces 136 of different types, allowing for connections to a variety of networks, such as local area networks or wide area networks including the Internet, via different sub-networks.

The distributed ledger node 132 can include an input/output circuit 138 configured to receive user input from and provide information to a user of the distributed ledger node 132. In this regard, the input/output circuit 138 is structured to exchange data, communications, instructions, and so on with an input/output component of the distributed ledger node 132. Accordingly, input/output circuit 138 may be any electronic device that conveys data to a user by generating sensory information (e.g., a visualization on a display, one or more sounds, tactile feedback, and so on) and/or converts received sensory information from a user into electronic signals (e.g., a keyboard, a mouse, a pointing device, a touch screen display, a microphone, and so on). One or more user interfaces may be internal to the housing of the distributed ledger node 132, such as a built-in display, touch screen, microphone, and so on, or external to the housing of the distributed ledger node 132, such as a monitor connected to the distributed ledger node 132, a speaker connected to the distributed ledger node 132, and so on, according to various arrangements. In some arrangements, the input/output circuit 138 includes communication circuitry for facilitating the exchange of data, values, messages, and the like between the input/output device and the components of the distributed ledger node 132. In some arrangements, the input/output circuit 138 includes machine-readable media for facilitating the exchange of information between the input/output device and the components of the distributed ledger node 132. In still another arrangement, the input/output circuit 138 includes any combination of hardware components (e.g., a touchscreen, biometric sensory), communication circuitry, and machine-readable media.

The distributed ledger node 132 can include a device identification circuit 140 (shown in FIG. 2A as device ID circuit 140) configured to generate and/or manage a device identifier associated with the distributed ledger node 132. The device identifier may include any type and form of identification used to distinguish the distributed ledger node 132 from other computing devices and/or other distributed ledger nodes. In some arrangements, a device identifier may be associated with one or more other device identifiers. In some arrangements, to preserve privacy, the device identifier may be cryptographically generated, encrypted, or otherwise obfuscated by any circuit of the distributed ledger node 132. In some arrangements, the distributed ledger node 132 may include the device identifier in any communication (any of the commands in FIG. 1A, e.g., a request to track command, an asset update command, a metadata retrieval command, and so on) that the distributed ledger node 132 sends to a computing device.

The distributed ledger node 132 can include an asset circuit 142 composed of asset source code 143 and an electronic exchange ledger 144. The asset source code 143 may be stored in memory of processing circuit 134, which may be accessed by and/or run on processing circuit 134. The electronic exchange ledger 144 may be stored on the same and/or different processor readable memory, which may be accessible by processing circuit 134 when running the asset source code 143. In some arrangements, the electronic exchange ledger 144 on a first node (e.g., node 132A in FIG. 1A) of a distributed ledger network corresponds with the electronic exchange ledger of one or more nodes within the distributed ledger network, to the extent that the nodes have synchronized/updated their electronic exchange ledgers (e.g., received the latest exchanges via a download or during a reconciliation process). Accordingly, the electronic exchange ledger 144 may be a public ledger.

In some arrangements, exchanges on a distributed ledger network include utilizing smart contracts (e.g., virtual contracts/agreements) As used herein, the phrase “smart contract” generally refers to a self-executing code (e.g., in a distributed ledger network or other system) that executes when a set of conditions that have been agreed upon by the parties of the smart contract are met. Although the figures and specification generally discuss utilizing smart contracts on assets, the systems, methods, and apparatuses disclosed herein can also be used for a plurality of and types of agreements, such as but not limited to deeds, leases, wills, non-smart contracts, traditional legal contracts, and other types of agreements between multiple parties. That is, parties to the smart contract or other types of agreements may be individuals, companies, organizations, and so on.

The distributed ledger node 132 can include at least one database 146. The database 146 can include data structures (e.g., datasets) for storing information such as the metadata about assets (e.g., smart contract execution history), unique tracking identifiers, distributed ledger node information, or additional information. Further, the data stored in the database 146 may include personal information (e.g., names, addresses, phone numbers, and so on), authentication information (e.g., username/password combinations, device authentication tokens, security question answers, unique client identifiers, biometric data, geographic data, social media data, and so on), and financial information (e.g., token information, account numbers, account balances, available credit, credit history, exchange histories, and so on) relating to the various assets. The database 146 can be part of the distributed ledger node 132, or a separate component that the distributed ledger node 132, asset issuer computing device 110, and/or entity computing devices 120 can access via the network 150. The database 146 can also be distributed throughout distributed ledger network 130 and/or system 100. For example, the database 146 can include multiple databases associated with the distributed ledger nodes on the distributed ledger network 130, asset issuer computing device 110, entity computing devices 120, or all three. In some arrangements, each node on the distributed ledger network 130 (e.g., 132A, 132B, 132C, 132D, 132E, and 132F) includes a database such that each database contains the same data (e.g., electric exchange ledger, unique tracking identifiers, and metadata about those unique tracking identifiers). In some arrangements, each data structure can be combined into one dataset.

The database 146 can include a data structure (e.g., dataset) associated with a unique tracking identifier dataset 147. The unique tracking identifier dataset 147 can include the unique tracking identifiers associated with specific assets. That is, the unique tracking identifier dataset 147 includes key value pairs, where the key is the specific asset and the value is a unique tracking identifier associated with the specific asset. For example, the key could be a loan and the value could be a unique tracking identifier that includes a subset of identifiers. In this example, the subset of identifiers could be a identifier (e.g., ISO 9362 standard) that uniquely identifies the issuer (e.g., bank or credit union) that issued the loan (e.g., asset issuer), a identifier (e.g., 1852) associated with the type of loan (e.g., asset type, e.g., title loan, payday loan, home equity loan, unsecured personal loan, and so on), and also a identifier (e.g., UUID-IETF RFC4122 Compliant) associated with a unique identifier. That is, in the above example, the unique tracking identifier associated with the loan is structured such that the unique tracking identifier can identify metadata associated with the asset as well as uniquely identify the asset throughout the lifecycle of the loan (e.g., Origination, Underwriting, Closing, Servicing, and so on).

In another example, the key could be a traveler's check and the value is a unique tracking identifier that includes a subset of identifiers. In this example, the subset of identifiers could be a identifier (e.g., 1111) that uniquely identifies the issuer that issued the traveler's check, a identifier (e.g., 2552) associated with the type of traveler's check (e.g., particular denomination-$50, $100, $250), and also a identifier associated with a unique identifier. That is, in the above example, the unique tracking identifier associated with the traveler's check is structured such that the unique tracking identifier can identify metadata associated with the asset as well as uniquely identify the asset throughout the lifecycle of the traveler's check (e.g., Issued, Redeemed, Voided, and so on).

In yet example, the key could be a prepaid debit card and the value is a unique tracking identifier that includes a subset of identifiers. In this example, the subset of identifiers could be a identifier (e.g., 5555) that uniquely identifies the issuer (e.g., Walgreens, Walmart, Amazon) that issued the prepaid debit card, a identifier (e.g., 1954) associated with the type of prepaid debit card (e.g., Visa, MasterCard, American Express, Discover), and also a identifier associated with a unique identifier. That is, in the above example, the unique tracking identifier associated with the prepaid debit card is structured such that the unique tracking identifier can identify metadata associated with the asset as well as uniquely identify the asset throughout the lifecycle of the prepaid debit card (e.g., Issued, Funded, Redeemed, Voided, and so on).

In some arrangements, the unique tracking identifier can also be associated with a plurality of metadata. That is, the unique tracking identifier can have a key value pair as well as metadata associated with the specific unique tracking identifier in the unique tracking identifier dataset 147. In some arrangements, metadata could include each smart contract that has been executed associated with that unique tracking identifier. In various arrangements, metadata could include any data that describes characteristics or aspects of the specific asset. For example, the characteristics could include geographic locations of the specific asset over the lifecycle of the specific asset. In another example, the characteristics could include security information (e.g., PIN, biometric information, account number, credit card number, security code, and so on) associated with the specific asset. In some arrangements, a unique tracking identifier and/or any metadata associated with the unique tracking identifier may be associated with one or more other unique tracking identifiers (e.g., a plurality of pre-paid debit cards provided to the same client). In some arrangements, to preserve privacy, the unique tracking identifier and/or any metadata associated with the unique tracking identifier may be cryptographically generated, encrypted, or otherwise obfuscated by any circuit of the distributed ledger node 132.

In some arrangements, a distributed ledger node 132 of a distributed ledger network (e.g., distributed ledger network 130 in FIG. 1A) may be configured to send and/or receive, via the network 150, data associated with the electronic exchange ledger 144 to an asset issuer computing device 110 and/or one or more entity computing devices 120. In various arrangements, a distributed ledger node 132 of a distributed ledger network (e.g., distributed ledger network 130 in FIG. 1A) may be configured to send and/or receive, via the network 150, data associated with the database 146 to an asset issuer computing device 110 and/or one or more entity computing devices 120. In some arrangements, after a successful completion and/or failure of an execution of a command/commands, the processing circuit 134/network interface 136 may provide a confirmation/failure notification to one or more systems described herein (e.g., system 100 in FIG. 1A).

In some arrangements, the distributed ledger node 132 may be configured to receive (via the network interface 136) a request to track command from the asset issuer computing device 110 and/or entity computing devices 120. The request to track command can designate a specific asset that includes a new unique tracking identifier associated with the specific asset. That is, the request to track a specific asset can cause the distributed ledger node 132 to update the unique tracking identifier dataset 147 with the new unique tracking identifier associated with the specific asset. In some arrangements, the updated unique tracking identifier dataset 147 is replicated across each distributed ledger node such that whenever one distributed ledger node gets updated (e.g., with the new unique tracking identifier) every other node also gets updated. Further, in response to a request to track command, the specific asset may be added to the electronic exchange ledger 144 such that any subsequent exchanges of the specific asset can be exchanged on the electronic exchange ledger 144 and tracked utilizing the provided new unique tracking identifier.

In some arrangements, the distributed ledger node 132 may be configured to receive (via the network interface 136) an asset update command from another distributed ledger node and/or the asset issuer computing device 110 and/or entity computing devices 120. The asset update command can designate a unique tracking identifier associated with the unique tracking identifier dataset 147. In some arrangements, the asset update command can also include data. That is, to maintain the accuracy of the electronic exchange ledger 144 and the unique tracking identifier dataset 147, the processing circuit 134 can update electronic ledger information and asset information associated with a particular unique tracking identifier based on receiving a unique tracking identifier along with the data to be updated.

Further, if an asset was exchanged off the distributed ledger network 130 (e.g., off-ledger exchange), the asset update command could include data associated with the off-ledger exchange. For example, if a title for car is exchanged based on a purchase of a car (e.g., off-ledger exchange) an asset update command may be sent by a computing device (e.g., entity computing devices 120 in FIG. 1A) that designates an exchange occurred along with any information associated with the exchange. Further, in this example, the distributed ledger node 132 can subsequently update the electronic exchange ledger 144 including the new exchange along with add additional data to the dataset (in the unique tracking identifier dataset 147) of the unique tracking identifier.

In some arrangements, the distributed ledger node 132 may be configured to receive (via the network interface 136) a metadata retrieval command from the asset issuer computing device 110 and/or entity computing devices 120. The metadata retrieval command can designate a unique tracking identifier associated with unique tracking identifier dataset 147. That is, the metadata stored in the unique tracking identifier dataset 147 can be provided to a computing device of the requester (e.g., asset issuer computing device 110) based on analyzing the one or more databases (e.g., database 146) and analyzing the electronic exchange ledger 144.

In some arrangements, the command may include a smart contract, that when executed by the distributed ledger node 132, causes the distributed ledger node 132 of the distributed ledger network 130 to monitor/detect the exchanges that are made by the distributed ledger node 132. The distributed ledger node 132 may store the smart contract in database 146. When an exchange request is sent or received by the distributed ledger node 132 on the distributed ledger network 130, the smart contract may execute and as a result update the electronic exchange ledger 144 and subsequently the unique tracking identifier dataset 147. In various arrangements, each command can include program code (e.g., a script, an executable, and so on) that, when executed by a distributed ledger node (e.g., 132A) of the distributed ledger network 130, causes the node to execute a specific set of instructions.

In various arrangements, the command may cause the distributed ledger node 132 to send the command (or copies thereof) to other nodes in the distributed ledger network 130, thereby causing those nodes to also perform the command. The distributed ledger node 132 can include a bus, such as an address/data bus or other communication mechanism for communicating information, which interconnects circuits and/or subsystems (e.g., asset circuit 142) of the distributed ledger node 132. In some arrangements, the distributed ledger node 132 may include one or more of any such circuits and/or subsystems.

In some arrangements, some or all of the circuits of the distributed ledger node 132 may be implemented with the processing circuit 134. For example, any of the distributed ledger node 132 may be implemented as a software application stored within the memory and executed by the processor of processing circuit 134. Accordingly, such arrangement can be implemented with minimal or no additional hardware costs. In some arrangements, any of these above-recited circuits rely on dedicated hardware specifically configured for performing operations of the circuit. In some arrangements, various nodes may be associated with an entity computing device (e.g., entity computing devices 120 in FIG. 1A). That is, each entity computing device may run a dedicated distributed ledger node. In this arrangement, the dedicated distributed ledger node could utilize resources of the entity computing device or vice versa.

Referring now to FIG. 2B, a block diagram depicting an example of an asset issuer computing device node 232 of the distributed ledger network 130 in FIG. 1B is shown, according to some arrangements. The asset issuer computing device node 232 is shown to include the identifier generation system 112 and the issuer database 114, as described with respect to FIG. 1A. Further, the asset issuer computing device node 232 is shown to include the processing circuit 134, the network interface 136, the input/output circuit 138, the device ID circuit 140, the asset circuit 142, the asset source code 143, the electronic exchange ledger 144, the database 146, and the unique tracking identifier dataset 147 as described with respect to FIG. 2A.

However, as shown, in some arrangements, the asset issuer computing device node 232 can be interconnected with the nodes (e.g., 132A, 132B, 132C, and so on) of the distributed ledger network 130 to form a peer-to-peer network (e.g., the distributed ledger network 130). Indeed, since the asset issuer node 232 is on the distributed ledger network 130, the asset issuer node 232 can perform various operations (e.g., asset tracking) on the distributed ledger network 130. For example, instead of communicating over the network 150 for various asset operation and related computing tasks, the asset issuer 232 can update assets, retrieve metadata, execute smart contracts, and/or various asset operations (e.g., communicating with nodes 132) on the distributed ledger network 130. That is, any of the nodes (e.g., 132A, 132B, 132C, 132D, 132E, 132F) in FIG. 1A and/or any of the nodes in FIG. 1B may be an asset issuer node 232. While various circuits, interfaces, and logic with particular functionality are shown, it should be understood that the asset issuer node 232 can include any number of circuits, interfaces, and logic for facilitating the functions described herein. For example, the activities of multiple circuits may be combined as a single circuit and implemented on a single processing circuit (e.g., processing circuit 134), as additional circuits with additional functionality are included. In some arrangements, the asset issuer node 232 can execute similar instructions to those of distributed ledger node 132 in FIG. 2A.

Now that the general structure of the system 100 has been described above, the following description provides an exemplary implementation of the system 100. It will be appreciated that the various components and the methods described above may be altered and/or omitted, as desired, for a given application. Further, it will be appreciated that the following description is provided as an example, and is in no way meant to be limiting.

In some instances, the distributed ledger employs a decentralized consensus algorithm configured to meet the performance requirements of applications on the blockchain (e.g., the distributed ledger network 130) via Delegated Proof of Stake (DPOS). Under this algorithm, those holders of tokens on the blockchain may select block producers through a continuous approval voting system performed via the blockchain system (e.g., the distributed ledger network 130). Anyone may choose to participate in block production and may be given an opportunity to produce blocks, provided they can persuade token holders to vote for them. In some instances, the nodes on the blockchain selected (e.g., voted) to produce blocks may be referred to as “delegates.” The delegates are thus nodes that confirm new blocks and provide the central processing units (CPUs) and random-access memory (RAM) that powers the distributed ledger network 130.

The software associated with the distributed ledger network 130 is configured to enable blocks to be produced exactly every 0.5 second, where exactly one producer (e.g., a node on the distributed ledger network 130) is authorized to produce a block at any given point in time. If the block is not produced at the scheduled time, then the block for that time slot may be skipped. When one or more blocks are skipped, there is a 0.5 or more second gap in the blockchain.

Using the distributed ledger network 130, blocks may be produced in rounds of 126 (6 blocks each, with 21 producers). For example, in some instances, at the start of each round 21 unique block producers are chosen by preference of votes cast by token holders (e.g., various nodes on the distributed ledger network 130). The selected producers may be scheduled in an order agreed upon by 15 or more producers.

If a producer misses a block and has not produced any block within the last 24 hours they may be removed from consideration until they notify the distributed ledger network 130 of their intention to start producing blocks again. This ensures the distributed ledger network 130 operates smoothly by minimizing the number of blocks missed by selectively not scheduling producers who are proven to be unreliable.

Under normal conditions a DPOS blockchain does not experience any forks because, rather than compete, the block producers cooperate to produce blocks. In the event there is a fork, consensus will automatically switch to the longest chain. This method works because the rate at which blocks are added to a blockchain fork is directly correlated to the percentage of block producers that share the same consensus. In other words, a blockchain fork with more producers on it will grow in length faster than one with fewer producers, because the fork with more producers will experience fewer missed blocks. Furthermore, no block producer should be producing blocks on two forks at the same time. Block producer caught doing this may be voted out by the token holders. Cryptographic evidence of such double-production may also be used to automatically remove abusers.

In some instances, Byzantine Fault Tolerance may be added to the distributed ledger network 130 by allowing all producers to sign all blocks so long as no producer signs two blocks with the same timestamp or the same block height. In some instances, once a predetermined number of producers (e.g., fifteen (15) producers) have signed a block the block is deemed irreversible. Accordingly, any byzantine producer would have to generate cryptographic evidence of their treason by signing two blocks with the same timestamp or block height. Under this model, an irreversible consensus should be reachable within one second.

In some instances, the blockchain (e.g., via the distributed ledger network 130) may have approximately 100% block producer participation. In these instances, transactions can be considered confirmed with 99.9% certainty after an average of 0.25 seconds from time of broadcast. Additionally, the blockchain is configured to incorporate asynchronous Byzantine Fault Tolerance (aBFT) for faster achievement of irreversibility. The aBFT algorithm may provide 100% confirmation of irreversibility within 1 second.

The blockchain (via the distributed ledger network 130) may be configured to perform transactions based on a Proof of Stake. That is, the blockchain may require every transaction to include part of the hash of a recent block header. This hash serves two purposes: 1) to prevent a replay of a transaction on forks that do not include the referenced block; and 2) to signal the network that a particular user and their stake are on a specific fork. Over time all users end up directly confirming the blockchain, which makes it difficult to forge counterfeit chains as the counterfeit would not be able to migrate transactions from the legitimate chain.

As described herein, users of the various nodes of the distributed ledger network 130 may be associated with various accounts. In some instances, the distributed ledger network 130 permits accounts to be referenced by a unique human readable name of up to 12 characters in length. The name may be chosen by the creator of the account. In some instances, the account creator must reserve sufficient RAM required to store the new account until the new account stakes tokens to reserve its own RAM.

In a decentralized context, application developers may pay the nominal cost of account creation to sign up a new user. Traditional businesses already spend significant sums of money per customer they acquire in the form of advertising, free services, etc. The cost of funding a new blockchain account should be insignificant in comparison. Fortunately, there is no need to create accounts for users already signed up by another application.

Using the distributed ledger network 130, each account can send (e.g., via the various nodes of the distributed ledger network 130) structured actions to other accounts and may define scripts to handle actions when they are received. As described herein, each account (e.g., node 132) may include its own private database (e.g., stored within database 146), which can only be accessed by its own action handlers. Action handling scripts can also send actions to other accounts. The combination of actions and automated action handlers may function to define smart contracts within the distributed ledger network 130.

To support parallel execution, each account may also define any number of scopes within their database. Further, the block producers will schedule transactions in such a way that there is no conflict over memory access to scopes, thereby allowing for the scheduled transactions to be executed in parallel.

In some instances, the various nodes of the distributed ledger network 130 may be configured to manage various permissions for various transactions. For example, permission management may involve determining whether or not an action is properly authorized. The simplest form of permission management may be checking that a transaction has the required signatures. However, this would imply that the required signatures are already known. In these instances, authority is bound to individuals or groups of individuals and is often compartmentalized. However, the distributed ledger network 130 may provide a declarative permission management system that gives accounts fine grained and high-level control over who can do what and when.

For example, it is beneficial for the authentication and permission management to be standardized and separated from the business logic of the application. This enables tools to be developed to manage permissions in a general-purpose manner and also provide significant opportunities for performance optimization. Accordingly, within the distributed ledger network 130, every account may be controlled by any weighted combination of other accounts and private keys. This may create a hierarchical authority structure that reflects how permissions are organized in reality and allows for effective and convenient multi-user control over accounts. Among other things, multi-user control may provide significantly increased security, and, when used properly, may greatly reduce the risk of theft due to hacking.

In some instances, the distributed ledger network 130 allows accounts to define what combination of keys and/or accounts can send a particular action type to another account. For example, in some instances, a user may have one key for their social media account and another for access to an exchange. In yet some other instances, a user may be allowed to give other accounts permission to act on behalf of the user's account without assigning them keys.

In some instances, the distributed ledger network 130 may be configured to allow for each account to be associated with named permission levels, each of which may be derived from higher-level named permissions. Each named permission level may define an authority; an authority is a threshold multi-signature check consisting of keys and/or named permission levels of other accounts. For example, an account's “Friend” permission level can be set for an action on the account to be controlled equally by any of the account's friends.

In some instances, the distributed ledger network 130 may have three hard-coded named permission levels: owner, active, and posting. Accounts having the posting permission can only perform social actions such as voting and posting, while accounts having the active permission can do everything except change the owner. Accounts having the owner permission are able to do everything, and the owner permission is meant for cold storage. In some instances, the distributed ledger network 130 may allow for a more generalize permission scheme by allowing each account holder to define their own hierarchy as well as the grouping of actions associated with each different permission level.

For example, the distributed ledger network 130 may allow each account to define a mapping between a contract/action or contract of any other account and their own Named Permission Level. For example, an account holder may map the account holder's social media application to the account holder's “Friend” permission group. With this mapping, any friend could post as the account holder on the account holder's social media. Even though they would post as the account holder, they would still use their own keys to sign the action. Accordingly, while friends can post as the account holder, the distributed ledger network 130 allows for the identification of which friends used the account and in what way.

The distributed ledger network 130 may evaluate differing permissions in a variety of ways. For example, when delivering an action of type “Payment” from a first user (e.g., “@alice”) to a second user (e.g., “@bob”), the distributed ledger network 130 (e.g., the various nodes 132) may first check to see if the first user (e.g., “@alice”) has defined a permission mapping for the second user at a first permission level (e.g., “@bob.groupa.subgroup Payment”). If no mapping is found for the second user at the first permission, then the distributed ledger network 130 (e.g., the various nodes 132) may check to see whether the first user has defined a permission mapping for the second user at a second permission level (e.g., “@bob.groupa”).

Once a mapping is identified, signing authority may be validated using a threshold multi-signature process and an authority associated with the named permission. For example, @alice could give permission to @bob and @joe's accounts to conduct transactions on @alice's behalf. In order to conduct a “Payment” for @alice, then @bob and @joe would both need to confirm the transaction while the distributed ledger network 130 evaluates permissions upon execution of the transaction. If the signing authority fails, then the validation process traverses up to the parent permission and ultimately to the owner permission (e.g., “@alice.owner”).

In some instances, the distributed ledger network 130 further allows all accounts to have an “owner” group, which can do everything, and an “active” group, which can do everything except change the owner group. All other permission groups may be derived from the “active” designation.

In some instances, the permission evaluation process may be “read-only,” such that changes to permissions made by transactions do not take effect until the end of a block. This means that all keys and permission evaluation for all transactions can be executed in parallel. Furthermore, this means that a rapid validation of permission is possible without implementing costly application logic that would have to be rolled back. Lastly, it means that transaction permissions can be evaluated as pending transactions are received and do not need to be re-evaluated as they are applied.

In some instances, permission verification may represent a significant percentage of the computation required to validate transactions. Accordingly, making this a read-only and parallelizable process enables a significant increase in performance.

Further, when replaying the blockchain to regenerate the deterministic state from the log of actions, there is no need to evaluate the permissions again. That is, the fact that a transaction is included in a known good block is sufficient to skip this step. This omission of having to reevaluate permissions also significantly reduces the computational load associated with replaying an ever-growing blockchain.

In several types of transactions, time may be a critical component of security. For example, in most cases, it is not possible to know if a private key has been stolen until it has been used. Time-based security may be even more critical when people have applications that require keys be kept on computers connected to the internet for daily use. To address these issues, the distributed ledger network 130 enables application developers to indicate that certain actions must wait a minimum period of time after being included in a block before they can be applied. During this delay period, the actions may be cancelled.

In some instances, the required delay may depend upon how sensitive an operation is. For example, paying for a coffee might have no delay and be irreversible in seconds, while buying a house may require a 72 hour clearing period. As another example, transferring an entire account to new control may take up to 30 days. In any case, the exact delays may be chosen by application developers and users (e.g., via the nodes 132 of the distributed ledger network 130).

Further, users may receive notice (e.g., via email or text message) when one of these delayed actions is broadcast (e.g., added as a block in the distributed ledger network 130). If the user associated with the action did not authorize it, then they may use an account recovery process to recover their account and retract the action.

For example, the distributed ledger network 130 may provide users with a method for restoring control of their account when keys are stolen. For example, in some instances, the distributed ledger network 130 may be configured such that an account owner may use any owner key that was active in the last 30 days, along with approval from their designated account recovery partner, to reset the owner key on their account. In these instances, the account recovery partner may not be allowed to reset control of the account without the help of the owner.

In the case of an account being hacked, there is nothing for the hacker to gain by attempting to go through the recovery process, because they already “control” the account. Furthermore, if they did go through the process, the recovery partner would likely demand identification and multi-factor authentication (phone and email). This two-factor recover process would therefore either compromise the hacker or gain the hacker nothing in the process.

This recovery process is also different from a simple multi-signature arrangement. For example, with a multi-signature transaction, another entity is made a party to every transaction that is executed. By contrast, with the recovery process discussed above, the recovery partner is only a party to the recovery process and has no power over the day-to-day transactions. This significantly reduces costs and legal liabilities for each user involved.

In general, blockchain consensus depends upon deterministic (reproducible) behavior. This means all parallel execution must be free from the use of mutual exceptions (mutexes) or other locking primitives. However, without locks there must be some other way to guarantee that transactions that may be executed in parallel do not create non-deterministic results.

Although, in some instances, the distributed ledger network 130 may be configured to run either single-threaded (i.e., executing various transactions in series) or multithreaded (i.e., executing various transactions in parallel).

In the distributed ledger network 130, parallel operation may be enabled by the block producers organizing action deliveries into independent shards so that they can be evaluated in parallel. The schedule may then be the output of a block producer and will be deterministically executed, while the process for generating the schedule need not be deterministic. Accordingly, block producers may utilize parallel algorithms to schedule transactions.

A by-product of parallel execution may be that, when a script generates a new action, the new action does not get delivered immediately. Instead, the new action may be scheduled to be delivered in the next cycle. For example, the reason the new action may not be delivered immediately is because the receiver of the new action may be actively modifying its own state in another shard.

Within the blockchain, latency is the time it takes for one account to send an action to another account and then receive a response. In some instances, the goal for latency may be to enable two accounts to exchange Actions back and forth within a single block with a latency of less than 0.5 seconds between each action. To enable this, the distributed ledger network 130 divides each block into regions, which may be further divided into cycles. Each cycle is divided into shards and each shard contains a list of transactions. Each transaction contains a set of Actions to be delivered. This structure can be visualized as a tree where alternating layers are processed sequentially and in parallel.

For example, in some instances, blocks may be created sequentially. The blocks may be divided into various regions configured to be processed in parallel. Each region may be further divided into cycles configured to be processed sequentially. Each cycle may be further divided into shards configured to be processed in parallel. Each shard may contain a plurality of transactions and actions configured to be processed or performed sequentially. Each transaction and/or action may have associated receivers and/or other accounts that may be notified of the transaction and/or action in parallel.

Accordingly, in some instances, transactions generated in one cycle can be delivered in any subsequent cycle or block. Block producers may keep adding cycles to a block until a maximum wall clock time has passed or there are no new generated transactions to deliver. Further, in some instances, static analysis of a block may be used to verify that, within a given cycle, no two shards contain transactions that modify the same account. So long as that invariant is maintained, the block can be processed by running all shards in parallel.

Some accounts within the distributed ledger network 130 may be able to process various Actions on a pass/fail basis without modifying their internal state. For example, if this is the case, then these handlers can be executed in parallel so long as only read-only Action handlers for a particular account are included in one or more shards within a particular cycle.

In some instances, it may be desirable to ensure that Actions are delivered to and accepted by multiple accounts automatically. In these instances, both Actions are placed in one transaction and both accounts will be assigned the same shard and the Actions applied sequentially.

In general, scaling blockchain technology may necessitate that components be modular. That is, every node within the distributed ledger system should not have to run everything, especially if they only need to use a small subset of the applications.

Accordingly, in some instances, an exchange application developer (e.g., the asset issuer computing device 110) may run full nodes for the purpose of displaying the exchange state to its users. However, this exchange application may have no need for the state associated with, for example, social media applications. As such, the distributed ledger network 130 allows any full node to pick any subset of applications to run. In these cases, Actions delivered to other applications may be safely ignored if the given application never depends upon the state of another contract.

In some instances, the distributed ledger network 130 may not be configured to obligate block producers to deliver any Actions to any other accounts. That is, each block producer may make their own subjective measurement of the computational complexity and time required to process a transaction. This may apply whether a transaction is generated by a user or automatically by a smart contract.

On the blockchain, at a network level (e.g., on the distributed ledger network 130) all transactions may be billed a computational bandwidth cost based on a number of WebAssembly (WASM) instructions executed. However, each individual block producer may calculate resource usage using their own algorithms and measurements. Accordingly, when a block producer concludes that a transaction or account has consumed a disproportionate amount of the computational capacity, they may simply reject the transaction when producing their own block. However, the block producer may still process the transaction if other block producers consider it valid.

In general, so long as even 1 block producer considers a transaction as valid and under the resource usage limits, then all other block producers will also accept it. However, in some instances, it may take up to 1 minute for the transaction to find that producer.

In some cases, a producer may create a block that includes transactions that are an order of magnitude outside of acceptable ranges. In this case, the next block producer may opt to reject the block and the tie will be broken by the third producer. This may be the same as what would happen if a large block caused network propagation delays. That is, the community would notice a pattern of abuse and eventually remove votes from the rogue producer.

Accordingly, in accordance with the systems and methods described herein, the subjective evaluation of computational cost frees the blockchain from having to precisely and deterministically measure how long something takes to run. As such, the systems and methods described herein do not need to precisely count instructions, which significantly increases opportunities for optimization without breaking consensus.

In some instances, the distributed ledger network 130 may further support deferred transactions that are scheduled to execute in the future. For example, the distributed ledger network 130 is configured to enable the computation process to move to different shards and/or the creation of long-running processes that continuously schedule a continuance transaction.

In general, most blockchains are resource constrained, and may require a system to prevent abuse. With the blockchain of the distributed ledger network 130, there are three broad classes of resources that are consumed by applications: (i) Bandwidth and Log Storage (Disk); (ii) Computation and Computational Backlog (CPU); and (iii) State Storage (RAM).

Bandwidth and computation each have two components: instantaneous usage and long-term usage. The blockchain maintains a log of all Actions, and this log is ultimately stored and downloaded by all full nodes. With the log of Actions, it is possible to reconstruct the state of all applications.

The computational debt is based on the calculations that must be performed to regenerate the state from the Action log. In some instances, if the computational debt grows too large, it may become necessary to take snapshots of the blockchain's state and discard the blockchain's history. Additionally, if computational debt grows too quickly, it may take a long time (e.g., as long as six months) to replay one year's worth of transactions. Accordingly, the distributed ledger network 130 (e.g., via the nodes 132) is configured to carefully manage the computational debt.

For example, blockchain state storage may be information that is accessible from application logic. Blockchain state storage may include various information, such as order books and account balances. However, if a given state is never read by the application, then it may not be stored. For example, blog post content and comments are generally not read by application logic, so, in some instances, they may not be stored in the blockchain's state. Meanwhile, the existence of a post/comment, the number of votes, and other properties may be read by the application, and may thus be stored as part of the blockchain's state.

In some instances, block producers may publish their available capacity for bandwidth, computation, and state. The distributed ledger network 130 is then configured to allow each account to consume a percentage of the available capacity proportional to the amount of tokens held in a 3-day staking contract. For example, if a blockchain on the distributed ledger network (e.g., based on the EOS.IO software) is launched, and if an account holds 1% of the total tokens distributable pursuant to that blockchain, then that account has the potential to utilize 1% of the state storage capacity.

Accordingly, the distributed ledger network 130 is configured to allocate bandwidth and computational capacity on a fractional reserve basis because they are transient (unused capacity cannot be saved for future use). As such, the algorithm utilized by the distributed ledger network 130 may be used to rate-limit bandwidth usage.

As described herein, modifications to constraints on computational usage have a significant impact on performance and optimization. Accordingly, within the distributed ledger network 130, all resource usage constraints may ultimately be subjective, and enforcement may be done by block producers according to their individual algorithms and estimates. In some instances, these constraints may be implemented by block producers via the writing of custom plugins.

However, there are certain items (e.g., states) that may be trivial to measure objectively. For example, the number of Actions delivered, and the size of the data stored in the internal database may be cheap to measure objectively. Accordingly, the distributed ledger network 130 is configured to enable block producers to apply similar algorithms over these objective measures, while possibly choosing to apply stricter subjective algorithms over subjective measurements.

Traditionally, it is the business entity that pays for office space, computational power, and other costs required to run the business. Meanwhile, the customer traditionally buys specific products from the business and the revenue from those product sales is used to cover the business costs of operation. Similarly, websites rarely, if ever obligate their visitors to make micropayments for visiting their website to cover hosting costs. Therefore, it may be desirable that decentralized applications do not force their customers to pay the blockchain directly for the use of the blockchain.

To address this issue, the blockchain of the distributed ledger network 130 does not require its users to pay the blockchain directly for its use (although it may be set up to do so), and therefore does not constrain or prevent a business from determining its own monetization strategy for its products.

For example, while the distributed ledger network 130 may allow, in some instances, for the receiver to pay for bandwidth, computation, and storage, the distributed ledger network 130 may also enable the sender to pay for the bandwidth, computation, and storage. As such, the distributed ledger network 130 allows for application developers to pick the method that is best for their application.

In many cases, a “sender-pays” model may significantly reduce complexity for application developers who do not want to implement their own rationing system. Accordingly, application developers can delegate bandwidth and computation to their users and then let the “sender-pays” model enforce the usage. In these instances, from the perspective of the end user the blockchain appears to be free, but from the perspective of the blockchain it is “sender-pays.”

In some instances, a holder of tokens on the blockchain of the distributed ledger network 130, who may not have an immediate need to consume all or part of the available bandwidth, can delegate or rent such unconsumed bandwidth to others. In these instances, the block producers on the blockchain may then recognize this delegation of capacity and allocate bandwidth accordingly.

Beneficially, the distributed ledger network 130 may allow for the amount of bandwidth available to an application to be entirely independent of any token price. That is, if an application owner holds a relevant number of tokens on the blockchain, then the application can run indefinitely within a fixed state and bandwidth usage. In such case, developers and users (e.g., associated with the various nodes 132) may be unaffected from price volatility in the token market, and therefore not reliant on a price feed. In other words, the blockchain described herein enables block producers to naturally increase bandwidth, computation, and storage available, per token, independent of the token's value.

In some instances, the blockchain may also award block producers tokens every time they produce a block. The value of these tokens will then impact the amount of bandwidth, storage, and computation a producer can afford to purchase. Accordingly, this model may naturally leverage rising token values to increase network performance.

While bandwidth and computation on the distributed ledger network 130 can be delegated, in some instances, the storage of application state may require an application developer to hold tokens until that state is deleted. However, if the state is never deleted, then the tokens may effectively be removed from circulation.

Governance is the process by which people in a community: (1) reach consensus on subjective matters of collective action that cannot be captured entirely by software algorithms; (2) carry out the decisions they reach; and (3) alter the governance rules themselves via Constitutional amendments.

The blockchain described herein may implement a governance process that efficiently directs the existing influence of block producers. For example, absent a defined governance process, prior blockchains relied on ad hoc, informal, and often controversial governance processes that resulted in unpredictable outcomes.

Conversely, within the blockchain on the distributed ledger network 130 power to alter the governance rules originates with the token holders who delegate that power to the block producers. For example, in some instances, the block producers are given limited and checked authority to freeze accounts, update defective applications, and propose hard forking changes to the underlying protocol.

Further, embedded into the blockchain on the distributed ledger network 130 is the election of block producers. Accordingly, in some instances, before any change can be made to the blockchain, the block producers must approve it. If the block producers refuse to make changes desired by the token holders, they can be voted out by the token holders. Additionally, if the block producers make changes without the permission of the token holders, then other non-producing full-node validators (exchanges, etc.) may reject those changes.

In some instances, the distributed ledger network 130 is configured to enable the blockchain to establish a peer-to-peer terms of service agreements or binding contracts among various users (e.g., various nodes 132) who sign it. These service agreements may generally be referred to as “user agreements.” The content of these agreements define obligations among the users which cannot be entirely enforced by code. Accordingly, these agreements may further facilitate dispute resolution by establishing jurisdiction and choice of law along with other mutually accepted rules. In some instances, every transaction broadcast on the network must incorporate the hash of the constitution as part of the signature, which may explicitly bind the signer to the contract.

In some instances, the user agreement also defines the human-readable intent of the source code protocol. This intent may be used to identify the difference between a bug and a feature when errors occur and may guide the community (e.g., the collective group of nodes 132 on the distributed ledger network 130) on what fixes are proper or improper.

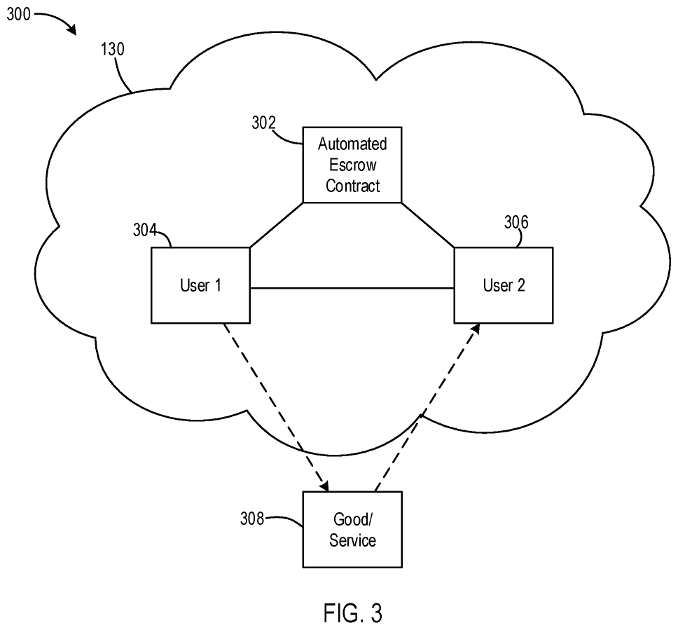

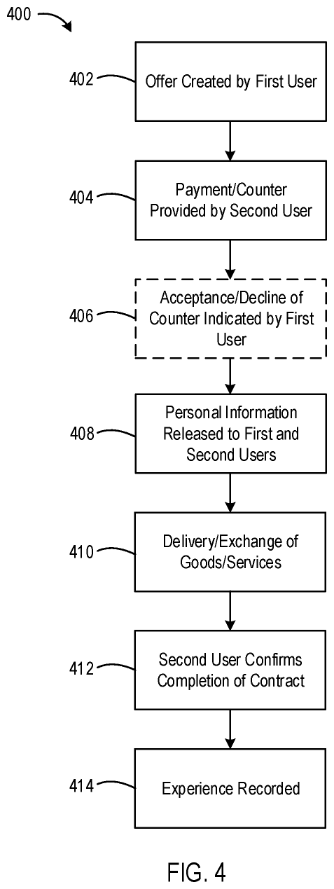

Referring generally now to FIGS. 3 and 4, in accordance with the discussion herein, the distributed ledger network 130 may allow for the creation and performance of decentralized coded escrow contracts (which may also be referred to herein as “automated escrow contracts”). At a high level, the automated escrow contracts are configured to enable two individuals to complete a payment or transfer of digital currency units, goods, and/or services without any direct interaction with an intermediary.

The automated escrow contract may be an application created by the asset issuer computing device 110 on the distributed ledger network 130. In some instances, the distributed ledger network 130 is configured such that the automated escrow contract is on the same rail or blockchain as the payments used within the automated escrow contract. The automated escrow contract application may be used by various users (e.g., nodes 132) and is configured to communicate ownership of various digital currency units, transfer ownership of the various digital currency units between member accounts, and enable an exchange of comments or reviews between users (e.g., member account holders) conducting the transactions to be posted on the blockchain of the distributed ledger network 130. It will be appreciated that the distributed ledger network 130 is configured to prevent any third party from editing or erasing the comments or reviews left by the member account holders.

For example, FIG. 3 illustrates a block diagram of an example system 300 for conducting an automated escrow contract 302 within the distributed ledger network 130. As shown, a first user 304 (e.g., “user 1”) and a second user 306 (e.g., “user 2”) may collectively create, form, and conduct the automated escrow contract 302. In some instances, the automated escrow contract 302 may be a contract for an exchange of payment for goods and/or services 308. In other instances, the automated escrow contract 302 may be a contract for an exchange of a first amount of one type of digital currency unit for a second amount of another. It will be appreciated that the automated escrow contract 302 may be utilized for a variety of agreement types, as desired for a given application.

Referring now to FIG. 4, a method 400 of creating and performing the automated escrow contract 302 is shown, according to various embodiments. As shown, the first user 304 may first create the automated escrow contract 302, at step 402. For example, the first user 304 may create the automated escrow contract 302 by specifying an item name (e.g., a unique identifier to be associated with the created automated escrow contract 302), an item description (e.g., generally describing the automated escrow contract 302), the contract information (e.g., elements of a Ricardian contract), a certificate indicating proof of ownership of the associated data (e.g., private and public key pairs, a virtual title (e.g., for a vehicle), a picture of an item for sale (e.g., for the sale of a general item, such as a carton of eggs)), an accepted state (e.g., originally set to “false,” and to be changed to “true” upon acceptance by the second user 306), a completed state (e.g., originally set to “false,” and to be changed to “true” upon confirmation by the second user 306 that the good, service, and/or digital currency unit has been received), an image hash, a deposit, and a stake. In some instances, the certificate indicating proof of ownership may itself be a smart contract that is issued to the recipient of a good or service and is configured to confirm ownership of the underlying asset that is being sold.

In some instances, the contract information may include information sufficient to create, and thus allows for the creation of, a Ricardian contract. For example, the contract information may include the price of the goods and/or services being offered (e.g., designated in one or more digital currency units), as well as any other miscellaneous information required to constitute an offer.

In some instances, if the first user 304 is offering an exchange of one digital currency for another digital currency, the deposit may include the amount of digital currency units being offered for exchange. In the case that the first user 304 is offering the goods and/or services 308, the first user 304 may not need to provide a deposit.

In some instances, the stake may be an amount of digital currency units required to be placed into an account of the automated escrow contract 302 to initiate the automated escrow contract 302. This staking requirement may effectively eliminate the capability for bad actors to spam the automated escrow contract 302.

For example, if there is a non-fungible digital currency unit that represents the ability to open an AEC, and known actors are delegated authorized users (e.g., allowed to perform these types of transactions) and only delegated authorized users can hold this non-fungible digital currency units, the staking requirement prevents non-delegated users (e.g., that are not allowed to perform these types of transactions) from engaging in smart contracts involving these types of transactions through spam. That is, the distributed ledger network 130 ignores or otherwise does not respond to service requests (e.g., requests for the formation of new smart contracts) if the request is not received from a known account and the request involves a transaction or staking off these non-fungible digital currency units. This staking process also prevents delegated authorized users from entering into exceedingly high numbers of transactions involving these non-fungible digital currency units by requiring a deposit for each requested smart contract.

Once the automated escrow contract 302 has been created by the first user 304, at step 402, the second user 306 may then provide payment for the automated escrow contract 302 or propose a counter offer, at step 404. For example, when created, the automated escrow contract 302 may include an “accepted” state, which may originally be set to “false.” If the second user 306 accepts the terms of the automated escrow contract 302, the second user 306 may accept the automated escrow contract 302 by depositing the amount of digital currency units into the account of the automated escrow contract 302. In this case, the accepted state may switch to “true.”

Alternatively, if the second user 306 wants to counter the offer of the first user 304, the second user 306 may create a counter proposal, which may be sent to the automated escrow contract 302. The counter proposal may include an item name (e.g., a unique identifier identifying the counter proposal), the accepted state (e.g., still set to “false,” and to be changed to “true” upon acceptance of the counter proposal by the first user 304), a deposit (e.g., sent to the account of the automated escrow contract 302 as stated in the contract information), a memo (e.g., including information which complies with requirements stated out in the contract information), and the completed state (e.g., still set to “false,” and to be changed to “true” upon confirmation by the second user 306 that the good, service, or digital currency unit has been received).

If the second user 306 has created the counter proposal, at step 404, the first user 304 may then accept or decline the counter proposal, at step 406. For example, the first user 304 may review the counter proposal via the blockchain of the distributed ledger network 130. If the first user 304 elects to decline the counter proposal of the second user 306, the method 400 may end. Alternatively, if the first user 304 accepts the terms of the counter proposal, the first user 304 may indicate their acceptance to the automated escrow contract 302, and the accepted state may switch to “true.” In some instances, off-chain software (e.g., between nodes 132 over networks other than the distributed ledger network 130) may be configured to monitor the transition of the accepted state from “false” to “true” on the blockchain.

If the initial offer from the first user 304 is accepted by the second user 306, or the counter proposal of the second user 306 is accepted by the first user 304, the automated escrow contract may then release various personal information of the first user 304 and the second user 306 (e.g., sending various personal information pertaining to the first user 304 to the second user 306, and vice versa), at step 408. For example, the various personal information may include the users' names, the users' addresses, the users' contact information (e.g., phone numbers, e-mail addresses), and/or any other pertinent information that may allow for the completion of off-chain components of the automated escrow contract 302.

After the various personal information has been released, at step 408, the users may meet in person to deliver and/or exchange the goods and/or services 308 agreed upon in the automated escrow contract 302, at step 410. The second user 306 may then confirm completion of the automated escrow contract 302 (e.g., by changing the completed state from “false” to “true”), at step 412. The confirmation of the second user 306 may trigger the automated escrow contract 302 to release or unlock the deposits within the account of the automated escrow contract 302 to be delivered to the first user 304 and/or the second user 306, as defined in the contract information.

After the automated escrow contract 302 has been confirmed as being completed, at step 412, the first user 304 and the second user 306 may each be allowed to record their transaction experience, at step 414. For example, the first user 304 and the second user 306 may each submit a description of their recorded experience to the automated escrow contract 302 to be publicly logged within the automated escrow contract 302, such that other users may view the recorded experiences of the first user 304 and the second user 306. Accordingly, the recorded experiences may supply knowledge to other users within the distributed ledger network 130 for future transactions. By providing the capability of publicly recorded transaction experiences in the context of the immutable blockchain, the distributed ledger network 130 may create a self-healing network of good actors who supply truthful information to the distributed ledger network 130. It should be appreciated that, in some examples, the recorded experiences (e.g., the review and counter review of the transaction) may only be modifiable after the completion of the automated escrow contract (i.e. when the completed state is set to “true”).

In some instances, the distributed ledger network 130 may be configured to assess a transaction fee on each completed automated escrow contract. For example, the transaction fee may be assessed on the digital currency units sent to the receiving address (e.g., from the first user 304 to the second user 306 and/or from the second user 306 to the first user 304). In some instances, the fee to use the automated escrow contract 302 may be one quarter to one half of one percent (0.25% to 0.5%) of the transaction amount charged to the receiving address.

The assessed transaction fees may then be automatically sent to and pooled within an allocated account associated with the asset issuer computing device 110 until the asset issuer computing device 110 is configured to distribute the pooled fees to various appropriate accounts on the distributed ledger network 130.

For example, as will be discussed in more detail below, various accounts may contain or hold varying numbers of reward units, and the pooled transaction fees may be paid out on a percentage basis based on the corresponding number of reward units held by each account within the distributed ledger network 130. For example, the distributed ledger network 130 may be configured to generate and maintain a predetermined number of reward units. In some instances, one hundred percent (100%) of the pooled fees charged for using the automated escrow contract 302 may be allocated to the holders of the reward units based on a percentage of the number of reward units the account holds compared to the total number of reward units within the distributed ledger network 130. For example, if an account holder holds five reward units, and the distributed ledger network 130 has a total of 100 reward units, that account hold would receive five percent (5%) of the total pooled transaction fees upon distribution. In some instances, the distributed ledger network 130 may be configured to generate and maintain 100, 1,000, 1,000,000, or any other number of total reward points.

In some instances, the distribution of the pooled transaction fees will involve updating the blockchain and associated values for each account. Accordingly, to minimize computation and storage costs, in some instances, the pooled transaction fees will be required to achieve a specific balance before the a distribution may occur.

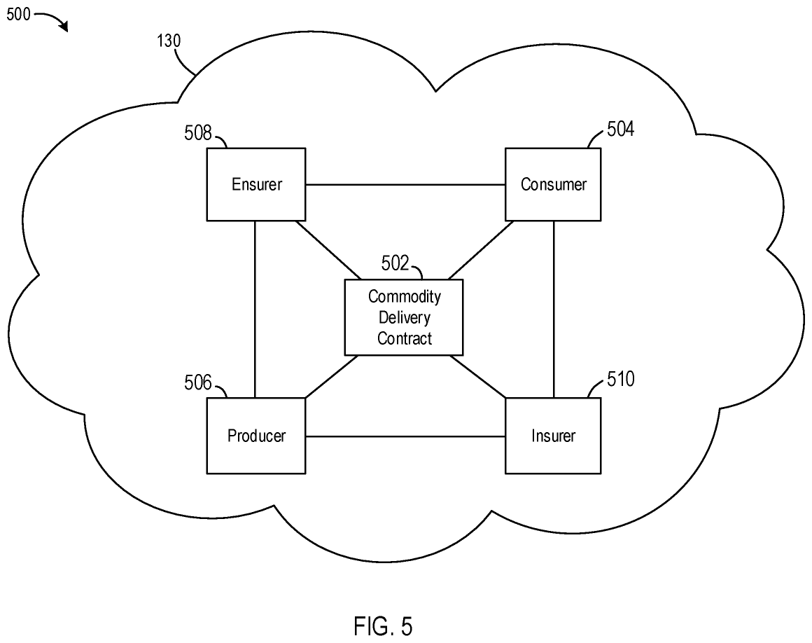

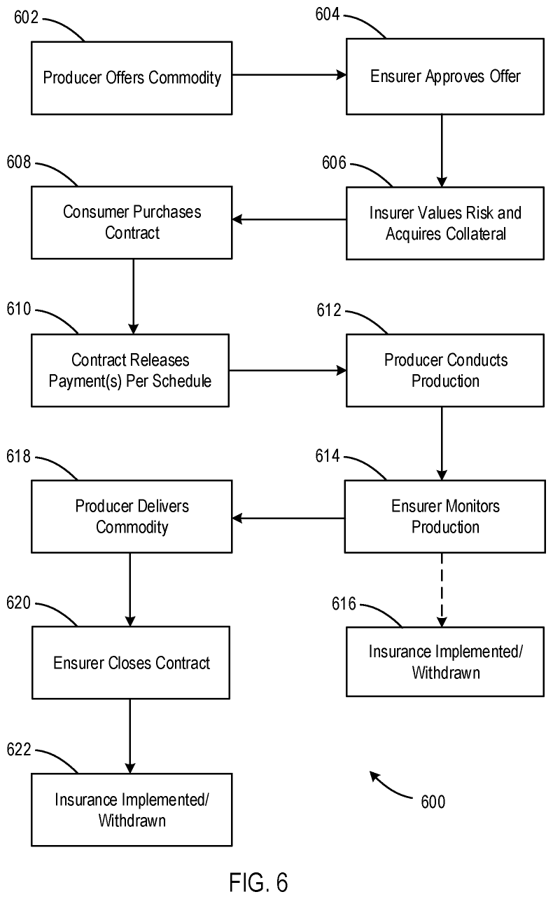

Referring generally now to FIGS. 5 and 6, in accordance with the discussion herein, the distributed ledger network 130 may further allow for the creation and performance of commodity delivery contracts between consumers and producers. The commodity delivery contracts may function similarly to the automated escrow contract described above, but further allow for the inclusion of a contract “ensurer” and a contract “insurer.” The contract “ensurer” may be responsible for closing the contract to ensure the commodity has been delivered as promised. The “ensurer” could be anyone that is a member of the distributed ledger network 130. The contract “insurer” may insure the delivery of the commodity to the consumer using either a payment or a commodity as collateral. The “insurer” may be anyone willing to provide collateral. In some instances, the “ensurer” and the “insurer” may be the same entity, but that may require a subdivision to be created within the commodity delivery contract. The commodity to be delivered can be any sort of good or service, as desired for a given application. For example, in some instances, the commodity delivery contract could be extended from miners to farmers (e.g., mining byproducts, agriculture goods). In some instances, the “commodity” could even be a service, such as the services of an expert academic or electrician.

For example, FIG. 5 illustrates a block diagram of an example system 500 for conducting a commodity delivery contract 502 within the distributed ledger network 130. As shown, a consumer 504, a producer 506, an ensurer 508, and an insurer 510 may collectively create, form, and conduct the commodity delivery contract 502. It will be appreciated that each of the consumer 504, the producer 506, the ensurer 508, and the insurer 510 may be respective nodes (e.g., nodes 132) within the distributed ledger network 130. In some instances, the commodity delivery contract 502 may be a contract for the production of a commodity in exchange for payment.

Referring now to FIG. 6, a method 600 of creating and performing the commodity delivery contract 502 is shown, according to various embodiments. As shown, in some instances, the producer 506 offers a commodity, at step 602, by creating the commodity delivery contract 502. For example, the producer 506 may create the commodity delivery contract 502 in a similar manner to that described above, with respect to the automated escrow contract 302, specifying an item name, an item description, the contract information, a certificate indicating proof of ownership of the associated data, an accepted state, a completed state, an image hash, a deposit, and a stake. However, in addition to the specifications in the automated escrow contract 302 discussed above, the commodity delivery contract 502 may further specify a request or requirement for an ensurer (e.g., the ensurer 508) and an insurer (e.g., the insurer 510) to be party to the contract as well.

Upon the creation of the commodity delivery contract 502, at step 602, the ensurer 508 may then approve the offer, at step 604. For example, in some instances, the ensurer 508 may review the offer prior to approval to ensure production capacity of the producer. In some instances, this review may include the ensurer 508 conducting due diligence of the commodity producer (e.g., producer 506). For example, in some instances, the ensurer 508 may conduct due diligence of the historical production, the current capacity, the planned output, a personnel review, a balance sheet review, a customer review, and/or a review of the risks (e.g., which would tend to increase the likelihood of the insurance being called upon) of the producer 506.

In some cases, upon approval by the ensurer 508, the insurer 510 may then value the risk of the commodity delivery contract 502 and acquire the appropriate collateral to insure delivery of the commodity, at step 606. For example, upon valuing the risk of the commodity delivery contract 502, the insurer 510 may then require that the producer 506 provide collateral in the form of a payment or commodity before approving the offer. In some other instances, the insurer 510 may provide their own collateral, but may charge an additional fee to the consumer 504 and/or the producer 506 for insuring the transaction. In some cases, the contract information may specify that approval by both the ensurer 508 and the insurer 510 is required prior to allowing other users (e.g., the consumer 504 to view and/or interact with the commodity delivery contract 502). It should be appreciated that, in some instances, the insurer 510 may value the risk and acquire the appropriate collateral, at step 606, prior to the ensurer approving the offer, at step 604.

Once the offer has been approved, the consumer 504 may then accept or purchase the commodity delivery contract 502, at step 608. For example, the consumer 504 may accept or purchase the commodity delivery contract 502 by transferring a preset amount of digital currency units to an account of the commodity delivery contract 502, which may change the accepted state from “false” to “true.” The preset amount may be an amount defined within the contract information. It should be appreciated that, when the consumer 504 accepts the commodity delivery contract 502, the commodity delivery contract 502 is insured (i.e., the delivery of the commodity is insured).

Once the contract has been accepted, the commodity delivery contract 502 may be configured to release payments to the producer 506 based on a predetermined payment schedule, at step 610. For example, the predetermined payment schedule may similarly be defined within the contract information. The predetermined schedule may further be configured to allow the producer 506 to meet various production requirements. The producer 506 may then conduct production of the commodities to be delivered to the consumer 504, at step 612, and the production may be monitored by the ensurer 508, at step 614. It will be appreciated that steps 610, 612, and 614 are all a part of the production process of the commodity to be delivered, and thus may be performed sequentially in any order or simultaneously in parallel.

If the production process (e.g., steps 610, 612, and 614) is not completed according to the details provided in the contract information, the insurance may be implemented or paid by the insurer 510 to the consumer 504, at step 616. For example, if the producer 506 is unable to produce the commodity or otherwise fails to deliver the commodity to the consumer 504, the insurer 510 may pay the consumer 504 a predetermined amount based on the contract information.

Alternatively, if the production process (e.g., steps 610, 612, and 614) is completed, the producer 506 may then deliver or otherwise provide the commodity to the consumer 504, at step 618. Once the commodity has been delivered or otherwise provided to the consumer 504, the ensurer 508 may then close the contract, at step 620, and the insurance may be withdrawn, at step 622. For example, the ensurer 508 may close the contract by communicating to the commodity delivery contract 502 that the contract has been fulfilled. Accordingly, upon the ensurer 508 closing the commodity delivery contract 502, the completed state may be changed from “false” to “true.” In some instances, where the insurer 510 received collateral from the producer 506, withdrawing the insurance may involve releasing the collateral back to the producer 506. In other instances, where the collateral was provided by the insurer 510 for a fee, withdrawing the insurance may simply be ending a period of liability on the part of the insurer 510.

It should be appreciated that, in some instances, the commodity delivery contract 502 may alternatively include only one of the ensurer 508 and the insurer 510, as desired for a given contract. In these instances, the steps involving the omitted ensurer or insurer may simply be omitted from the method 600, which may be specified within the contract information.

In some instances, the distributed ledger network 130 may similarly be configured to assess a transaction fee on each completed commodity delivery contract (as discussed above, with respect to the automated escrow contract 302). The assessed transaction fees may then similarly be pooled within the allocated account (e.g., an account associated with the asset issuer computing device 110 (e.g., along with the transaction fees from any automated escrow contracts)), until the distributed ledger network 130 is configured to distribute the pooled fees to various appropriate accounts on the distributed ledger network 130, as discussed above.

It should be appreciated that the distributed ledger network 130 may allow for the transfer of a variety of digital currency units. In some instances, the software protocol of the distributed ledger network 130 may be configured to ensure that a finite amount of fungible digital currency units exist at any one moment in time.

Traditional blockchain protocols (e.g., the Bitcoin protocol) have had significant limitations. For example, the Bitcoin protocol can only account for one digital currency, “Bitcoin,” with a limited number of transactions per block while each block settles within ten minutes. However, the software protocol utilized by the distributed ledger network 130 (e.g., EOS.IO) can carry many digital currency units in parallel and settle Blocks in seconds.

In some instances, an account (e.g., associated with the asset issuer computing device 110) on the distributed ledger network 130 can issue its own digital currency units that can represent anything and everything. Smart Contracts (e.g., the automated escrow contract 302 and the commodity delivery contract 502) operating on the distributed ledger network 130 create the capability of other accounts within the distributed ledger network 130 to interact with each other given predefined rules of engagement (e.g., for gaming, bartering, etc.).

For example, in some instances, the distributed ledger network 130 may be configured to support three classes of digital currency units for use by its members. Additionally, in some instances, the distributed ledger network 130 may be configured to limit the use or performance of automated escrow contracts (e.g., the automated escrow contract 302) and/or commodity delivery contracts (e.g., the commodity delivery contract 502) to restrict the transfer of the supported digital currency units between delegated authorized user accounts of registered participants. For example, in some instances, various accounts (e.g., nodes 132) may be able to register their accounts on the distributed ledger network 130 by communicating with a provider (e.g., the asset issuer associated with the asset issuer computing device 110). In some instances, this communication may take place via a network (e.g., communication between the nodes 132 and the asset issuer computing device 110). In other instances, the various accounts may be able to register in other ways, as desired for a given application.

For example, in some instances, the three classes of digital currency units may include: Legal Tender digital certificates, Cryptocurrency digital certificates, and “CRAM.”

For example, Legal Tender certificates may include digital claims issued by the asset issuer computing device 110 (e.g., Dollars of Gold or Silver). Dollars of Gold or Silver are fully reserved digital dollars of gold (USDG) or silver (USDS). The underlying property of the issued Legal Tender digital certificates may be vaulted by a Trust in a private vaulting agreement, thereby reducing the risk of confiscation of the property. In some instances, USDG and USDS certificates for fully reserved dollars of gold and silver may be audited and videoed by United Precious Metals Association (UPMA) on a daily basis to increase trust.

In some instances, a Dollar of Gold or Silver may represent 1 gram of gold or 1 gram of silver, while 31.103 Dollars of Gold or Silver may represent a fully reserved U.S. Mint Dollar of gold (USDG) or silver (USDS). In some instances, there may be four ways for members to obtain Dollars of Gold or Silver. The primary way may be to transfer dollars of gold or silver into a UPMA account of the asset issuer computing device 110. In this case, the asset issuer computing device 110 may then issue the corresponding member the appropriate number of USDG or USDS certificates based on the amount of their transfer. In some instances, there may be a fee (e.g., 1%) associated with obtaining Dollars of Gold or Silver through this primary process assessed by the asset issuer computing device 110. In some instances, a minimum amount of dollars of silver (e.g., 21) may be required

The secondary way for members to acquire Dollars of Gold or Silver may be through an automated escrow contract (e.g., the automated escrow contract 302) or a commodity delivery contract (e.g., the commodity delivery contract 502) exchanging other digital currency units for Dollars of Gold or Silver or offering goods, commodities, and/or services in exchange for Dollars of Gold or Silver from other members.

A tertiary method for members to acquire Dollars of Gold or Silver may be through the ownership of “promise to pay” digital currency units (e.g., CRAM. For example, in some instances, “promise to pay” digital currency units may earn a percentage of the transaction fees charged by the asset issuer computing device 110 when members use automated escrow contracts and/or commodity delivery contracts. Accordingly, owning these “promise to pay” digital currency units (e.g., CRAM) may provide a method for passively acquiring more Dollars of Gold or Silver. In some instances, ownership of Dollars of Gold or Silver may similarly allow the holders of the Dollars of Gold or Silver to earn a portion of the transaction fees collected by the distributed ledger network 130. In these instances, the distributed ledger network 130 would be treating the holder of the Dollars of Gold or Silver as pseudo owners of CRAM (e.g., the owners of the Dollars of Gold or Silver receive a portion of the transaction fees), even if they do not own any CRAM.

A quaternary method to acquire Dollars of Gold or Silver may be through earning the Dollars of Gold or Silver through a user's time and energy. For example, in some instances, users of the distributed ledger network 130 may earn Dollars of Gold or Silver through various incentive programs (e.g., by mining other types of digital currencies for use on the distributed ledger network 130).

The redemption of Dollars of Gold or Silver may require that a member have a UPMA account. In some instances, the USDG or USDS certificates may be sent to an automated escrow contract created by the asset issuer computing device 110 for the redemption process. Accordingly, the ownership of the Dollars of Gold and Silver may be transferred via the blockchain.

In some instances, cryptocurrency certificates may be referred to as crypto chips. Crypto chips may be redeemable on demand for the decentralized cryptocurrency each crypto chip represents. In some instances, only a few cryptocurrencies may be included or accepted in the distributed ledger network 130. For example, in some instances, the main accepted cryptocurrencies may be Proof of Work protocols.

A crypto chip is thus a claim on a fully reserved decentralized cryptocurrency owned by the asset issuer computing device 110. In some instances, there may be three ways for members to acquire crypto chips. The primary way to acquire crypto chips is to mine them via the member's computing power and electricity, with the resulting block rewards being sent directly to a public address owned by the asset issuer computing device 110. Directly sending the block rewards to the asset issuer computing device 110 allows the member to bypass a cost basis and defer income for the members, because they never own the public key. Instead, the members receive a corresponding crypto chip issued by the asset issuer computing device 110 as a deferred liability on the asset issuer's balance sheet. In some instances, there may be a fee (e.g., 1.5%) charged for issuing mined crypto chips with two-thirds of the fee being allocated to the “promise to pay” digital currency unit (e.g., CRAM) holders.

A second way for members to acquire crypto chips may be for members to send their cryptocurrency to the public address of the asset issuer computing device 110. In this case, when the protocol verifies the cryptocurrency units have been sent to the public address of the asset issuer computing device 110, then a corresponding smart contract (e.g., similar to the automated escrow contract 302) may automatically issue the corresponding amount of crypto chips to the member's account for use within the distributed ledger network 130 (e.g., to conduct automated escrow contracts, commodity deliver contracts, and/or other activities). In some instances, there may be no fee for this transaction.

A third way to acquire crypto chips is similarly by exchanging other digital currency units, goods, and/or services for crypto chips via automated escrow contracts.

The CRAM or “promise to pay” digital currency units represent the accounting of the transaction fee distribution captured by the asset issuer computing device 110 via automated escrow contracts performed on the distributed ledger network 130, as well as two-thirds of the fees collected through mined crypto chips.

In some instances, only a predetermined number (e.g., 100, 1,000, 1,000,000) of CRAM digital currency units may ever be created by the asset issuer computing device 110 and distributed within the distributed ledger network 130. For example, in some instances, a portion of the CRAM digital currency units (e.g., one third) may be distributed to members based upon the number of individuals they refer into the distributed ledger network 130 (e.g., as tracked via referral codes). Another portion may be distributed to USDG and USDS owners. Yet another portion may be distributed to a first number of members to join the distributed ledger network 130. Another portion may be distributed to the members of the distributed ledger network 130 as a vanishing yield, as will be discussed below. The asset issuer computing device 110 may own the remainder of the CRAM digital currency units and allocate the yield generated to vaulting, software sustainment, and various business costs (e.g., salaries).

An example initial distribution of CRAM digital currency units in a system having 1,000,000 units of CRAM digital currency units is provided in Table 1 below. It will be appreciated that this distribution is provided as an example and is in no way meant to be limiting. That is, a variety of other distributions are possible and are contemplated by the present disclosure.

TABLE 1
CRAM Allocation

| CRAM | Allocation |
|---|---|
| 367,000 | Trustee for vaulting & software sustainment |
| 111,000 | .111 per referral for first 1 million referrals |
| 111,000 | .0111 per referral for next 10 million referrals |
| 111,000 | .00111 per referral for next 100 million referrals |
| 100,000 frozen | Yield distributed to USDG Owners |
| 100,000 frozen | Yield distributed to USDS Owners |
| 100,000 frozen | Vanishing Yield for Members |

In the example provided above, the yield generated from 200,000 frozen CRAM may be allocated to the owners of Dollars of Gold or Silver. As used herein, the term “frozen” may be used to signify that the yield (e.g., the CRAM) is cryptographically sealed in a smart contract. Accordingly, the amount of “frozen” CRAM is a constant amount, thereby allowing for the yield to be allocated to the owners of Dollars of Gold or Silver in proportion to the CRAM amount frozen. This freezing of the CRAM allows for Metcalfe's Law (e.g., the value of a telecommunication network being proportional to the number of interconnected nodes squared) to be realized by providing a finite number of interconnected nodes at the time of disbursement. That is, the amount of CRAM is finite.

At the time each transaction fee is captured by an automated escrow contract and/or a commodity delivery contract, each member's personal share of the total issued certificates will be referenced, and the resulting yield will be automatically calculated and allocated to the member. For example, if there were 100 USDS certificates in circulation, and a member owned 1 USDS, then they would earn the yield from 10,000 CRAM (equivalent of 1% of the total transaction fees in this example).

Accordingly, as transaction fees grow (e.g., in multiple currencies) within the distributed ledger network 130, CRAM ownership delivers an increasing benefit. Further, by realizing Metcalfe's Law through use of the CRAM and the associated CRAM freezing process discussed above, the distributed ledger network 130 is able to be valued, as the CRAM provides a unit that measures the desire of the users of the distributed ledger network 130 to acquire more ownership of the network transaction fees and other benefits discussed herein. Furthermore, the use of CRAM allows for users (e.g., holders of CRAM) to receive both a return in multiple currencies (e.g., different currency types) based on the transaction fees accumulated and an increasing purchasing power of the underlying currencies delivered apart from the transaction fees.

Additionally, in the example provided above, the yield generated by 100,000 frozen CRAM will be allocated equally amongst the all of the members of the distributed ledger network 130. This yield will be available for distribution on a predetermined (e.g., monthly) basis, but will only exist for members to use in transaction for the predetermined time period (e.g., one month) once made available. This may be referred to as a Vanishing Yield for Members (VYM) and helps ensure a minimal level of transactions across the distributed ledger network 130. Members who do not spend their VYM automatically relinquish it back to the asset issuer computing device 110. However, if these VYM CRAM are transacted once, they become non-vanishing CRAM digital currency units.

In some instances, if a member owns over a preset number of CRAM digital currency units (e.g., 44 or more CRAM digital currency units) their transaction fee may be reduced (e.g., cut in half).

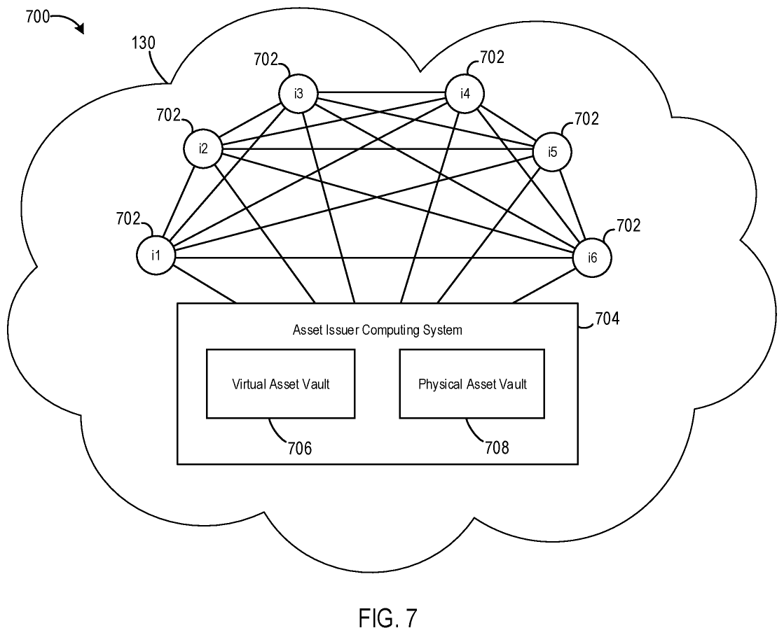

Referring now to FIG. 7, an example user ecosystem 700 within the distributed ledger network 130 is illustrated, according to various embodiments. For example, the user ecosystem 700 may include a plurality of nodes 702 (e.g., each associated with users having differing identities i1-i6) and an asset issuer computing device 704. Each of the nodes 702 may be substantially similar to the nodes 132, described above. Each of the nodes 702 may further be associated with users having different identities (e.g., i1-i6). The asset issuer computing device 704 may similarly be substantially similar to the asset issuer computing device 110 (or asset issuer computing device 232) described above.

However, the asset issuer computing device 704 may further include a virtual asset vault 706 and a physical asset vault 708. In some instances, the virtual asset vault 706 is configured to store virtual assets (e.g., cryptocurrencies, “promise to pay” digital currency units, vital records) that may allow for the generation and use of crypto chips, “promise to pay” digital currency units (e.g., CRAM digital currency units), and/or the transfer of vital records between various users within the distributed ledger network 130. The physical asset vault 708 is configured to store various physical assets, such as metals (e.g., gold, silver) and plastic, to allow for the generation and use of corresponding metal and plastic digital currency units within the distributed ledger network 130.

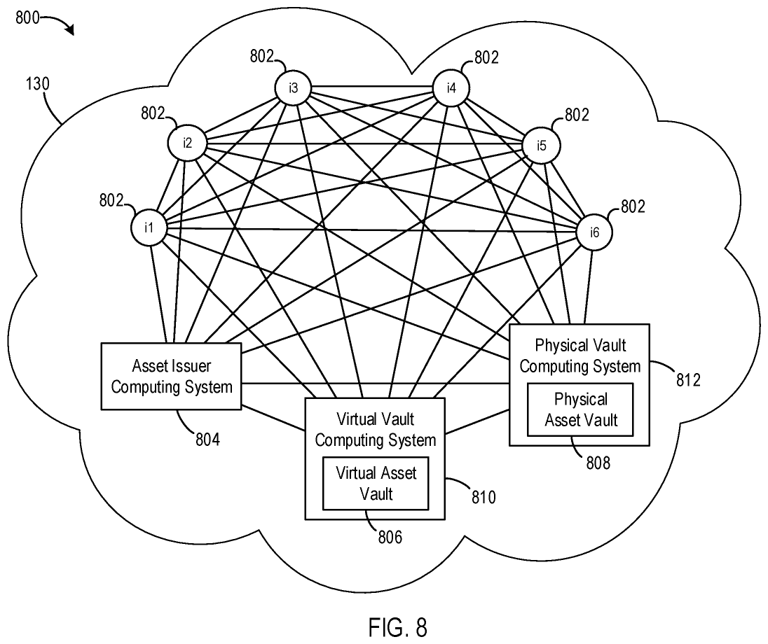

Referring now to FIG. 8, an example user ecosystem 800 within the distributed ledger network 130 is illustrated, according to various embodiments. The example user ecosystem 800 may be substantially similar to the example user ecosystem 700. For example, the user ecosystem 800 may similarly include a plurality of nodes 802 and an asset issuer computing device 804. However, the virtual asset vault 806 and the physical asset vault 808 of the user ecosystem 800 may alternatively be controlled and operated by a virtual asset computing system 810 and a physical asset computing system 812, respectively, as opposed to being controlled and operated by the asset issuer computing device 804.

In either case, the user ecosystems described above (e.g., the user ecosystem 700 and the user ecosystem 800) may be configured to allow the various users of the various nodes to effectively transfer a variety of differing digital currency units, perform various desired transactions (e.g., automated escrow contracts, commodity delivery contracts), have automatic fee distributions paid out, and/or have various vital records transferred.

For example, in some instances, the distributed ledger network 130 may be an open source MiT graphene DLT network. The distributed ledger network 130 may be provisioned such that all delegates are owned by an asset owner or provider (e.g., a financial institution) associated with the asset issuer computing device 704. In some instances, each account (e.g., associated with each user of each node 702) is a named account that may be a delegated authorized user (e.g., allowed to perform transactions) or restricted ineligible user (e.g., not allowed to perform transactions). The distributed ledger network 130 may be configured to allow for encrypted communications and have the capacity to enable millions of transactions per second. As discussed above, a percentage of the transaction fees collected within the distributed ledger network 130 are provided back to holders of “promise to pay” digital currency units (e.g., “CRAM”). In some instances, the distributed ledger network 130 may be valued based on the “promise to pay” digital currency units.

As discussed above, the “promise to pay” digital currency units (e.g., “CRAM”) function as a promise to pay a corresponding proportion of the transaction fees of the network. These “promise to pay” digital currency units are finite, fungible, divisible currency with return denominated in exogenous currencies. In some instances, these transaction fees may be denominated in multiple currencies for each transaction block conducted within the distributed ledger network 130. Legal tender certificates (e.g., dollars of gold and dollars of silver) may also be utilized within the distributed ledger network 130. The legal tender certificates may function as nontaxable currency within the distributed ledger network 130 that are independent of the Federal Reserve System, thereby reducing systematic risk. In some instances, the distributed ledger network 130 further includes “network profit” machines configured to produce profit for network distribution. These “network profit” machines are associated with or otherwise encompassed by one or more business units (e.g., business unit computing systems or devices associated with the distributed ledger network 130).

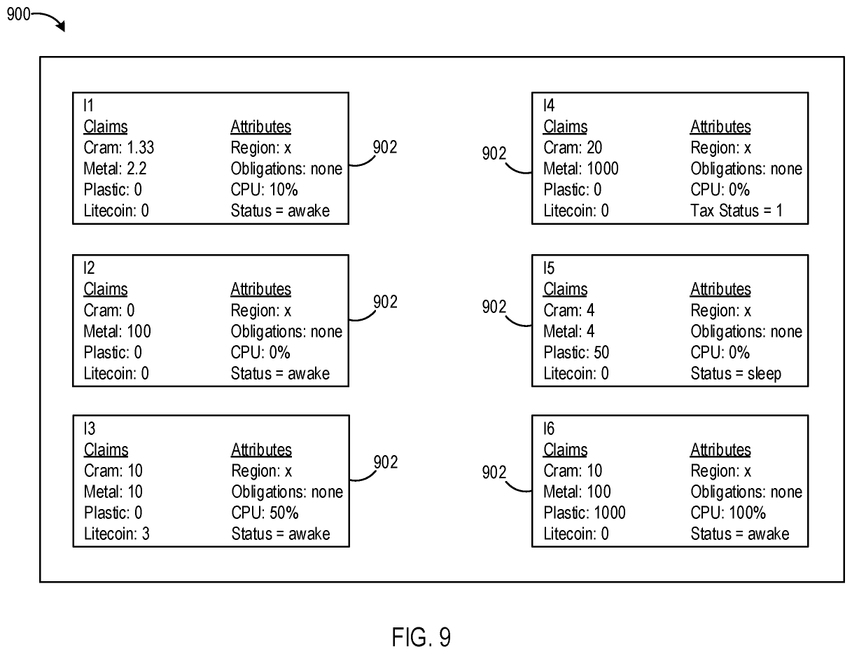

Referring generally to FIGS. 9-19, example processing for conducting various transfers on the distributed ledger network 130 is shown and will be discussed below. While the following discussion of the example processing will be provided in the context of the example user ecosystem 700, it should be appreciated that the example processing may be similarly conducted within the user ecosystem 800 or any other suitable user ecosystem on the distributed ledger network 130. It will further be appreciated that a benefit of the distributed ledger network 130 is that it may host a variety of interconnected user ecosystems, such that a variety of different processing methods could be conducted, as desired for a given application. Accordingly, the following discussion is provided as an example and is not meant to be limiting.

As will be described, the distributed ledger network 130 is configured to host a variety of software processes, such as various holds for daily withdrawals (e.g., referred to as “S1”), commodity delivery contracts (or automated escrow contracts) (e.g., referred to as “S2”), crypto claim deliveries (e.g., referred to as “S3”), and passive authentication (e.g., referred to as “S4). In some instances, each of the various software processes may be created and/or maintained by the asset issuer computing device 704. However, it will be appreciated that a variety of other types of software processes may be hosted or otherwise conducted on the distributed ledger network 130, and the software process may be created and/or maintained by any other nodes on the distributed ledger network, as desired for a given application.

Referring now to FIG. 9, an accounts view 900 of a plurality of user account information windows 902 is shown. Each user account information window 902 corresponds to a particular user (e.g., users 1-6 represented as i1-i6) and includes the user's claims and attributes. For example, the user's claims include the amount of CRAM (or “promise to pay” digital currency units), metal claims (e.g., gold dollar or silver dollar certificates), plastic (e.g., plastic certificates), and crypto chips (e.g., Litecoin certificates or crypto chips). The user's attributes may include the user's region, obligations, CPU percentage, and status. In some instances, each user's account information may be encrypted and only available to specific computing systems through the use of key pairs.

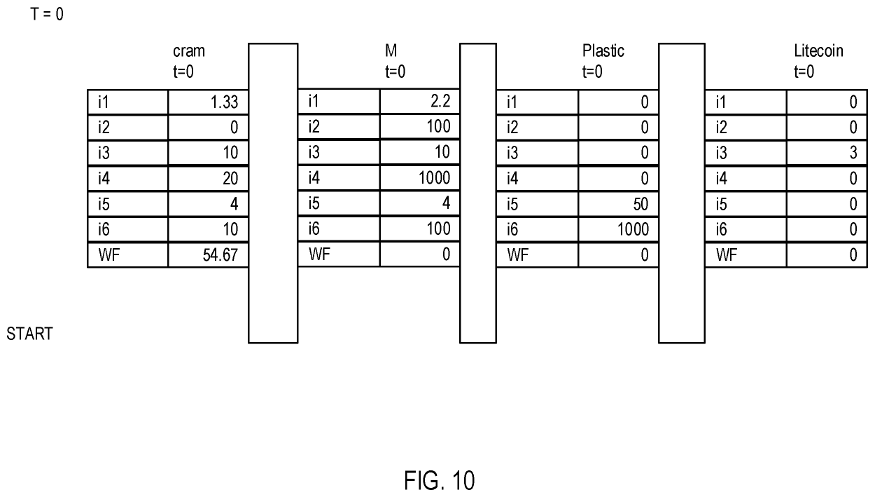

Referring now to FIG. 10, a table is provided showing initial account values for each of the users (i1-i6) and the account issuer (“WF”) for each of “promise to pay” digital currency units (“CRAM”), digital metal claims (“M”), digital plastic claims (“Plastic”), and Litecoin crypto chips (“Litecoin” or “LTC”) at an initial time (T=0). It should be appreciated that various other types of digital currency units may be utilized, as desired for a given application, and that the digital currency units described with reference to FIGS. 9-19 are provided as examples. For example, although Litecoin crypto chips are provided in FIGS. 9-19, it should be appreciated that any other type of crypto chip corresponding to any other type of cryptocurrency may be used. Additionally, in some instances, several different crypto chips may be utilized simultaneously.

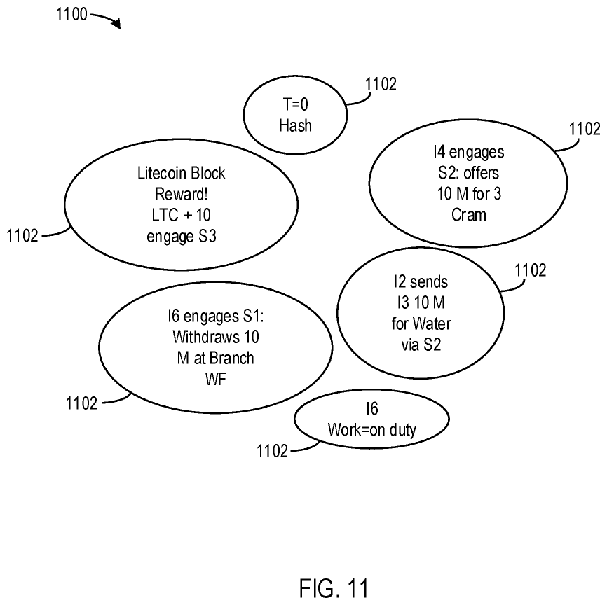

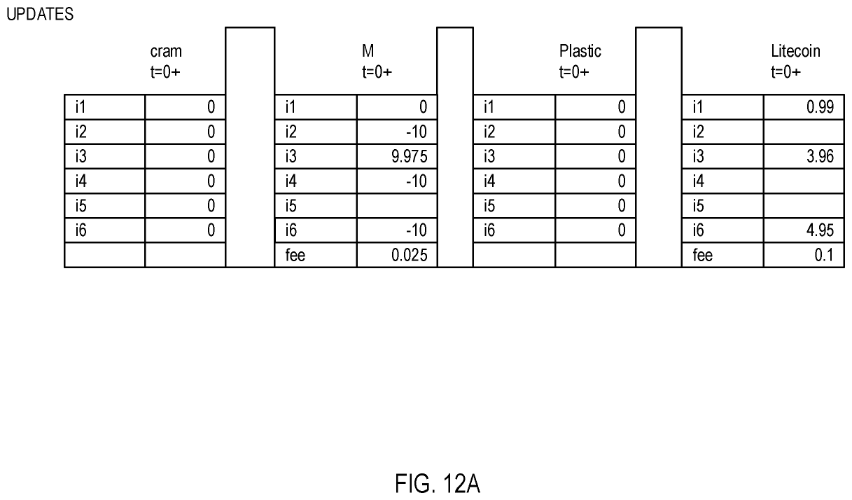

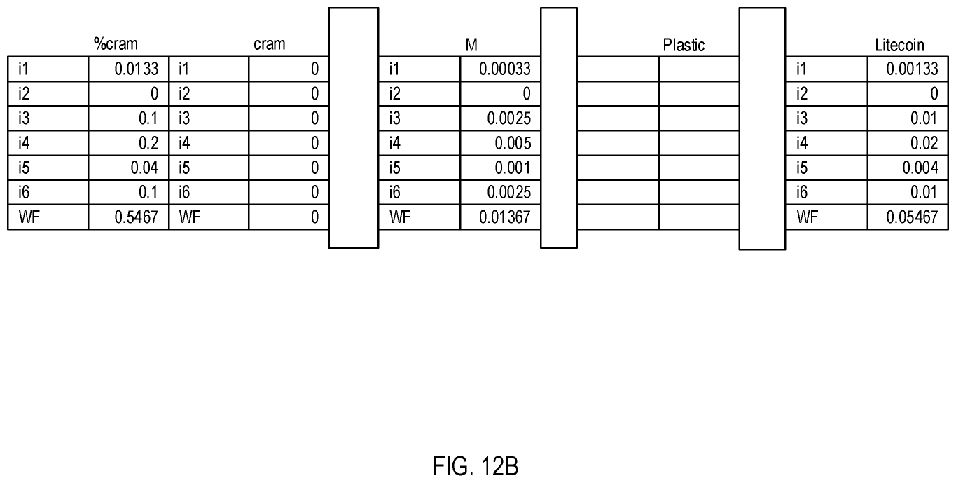

Referring now to FIG. 11, a state diagram 1100 is provided showing a plurality of actions 1102 configured to occur at a first action time (T=0). For example, at the first action time, a Litecoin Block Reward is distributed. For example, the Litecoin Block Reward is performed via software process S3, in which the asset issuer computing device 704 may deposit and distribute a predetermined number of Litecoin crypto chips to users based on their relative CPU percentage. In the provided example, the predetermined number of Litecoin crypto chips is ten (10) crypto chips. Additionally, users 1 (i1), 3 (i3), and 6 (i6) were determined to have relative CPU percentages of 10%, 40%, and 60%, respectively. Accordingly, as shown in FIG. 12A (showing the action-based account updates), the asset issuer computing device 704 sends 1 LTC, 4 LTC, and 5 LTC to users 1 (i1), 3 (i3), and 6 (i6) respectively, but also assesses a 1% reward transaction fee (e.g., to be pooled for distribution as shown in FIG. 12B). It should be noted that, in some instances, the reward transaction fee may be set to a different value than the transaction fees associated with automated escrow contracts between users.

Additionally, at the first action time, user 4 (i4) offers 10 M for 3 CRAM via software process S2. Accordingly, as shown in FIG. 12A, the asset issuer computing device 704 is configured to withdraw and freeze 10 M from the account of user 4 (i4). Further, at the first action time, user 6 (i6) withdraws 10 M at a branch associated with the asset issuer computing device 704, via software process S1. The asset issuer computing device 704 thus withdraws 10 M from the user 6 (i6) account, as shown in FIG. 12A, and freezes the 10 M for one day to enable the withdrawal. If the withdrawal is successful, the 10 M will be “burned” or otherwise deleted. Otherwise, it may be returned to the user 6 (i6) account.

Additionally, at the first action time, user 2 (i2) sends user 3 (i3) 10 M for water, via software process S2. This transaction may be provided with the description “water” to be logged on the blockchain. Further, as shown in FIG. 12A the asset issuer computing device 704 assesses a 0.25% fee on the transaction between user 2 (i2) and user 3 (i3). Further, at the first action time, user 6 (i6) has his or her work status changed to “on duty.”

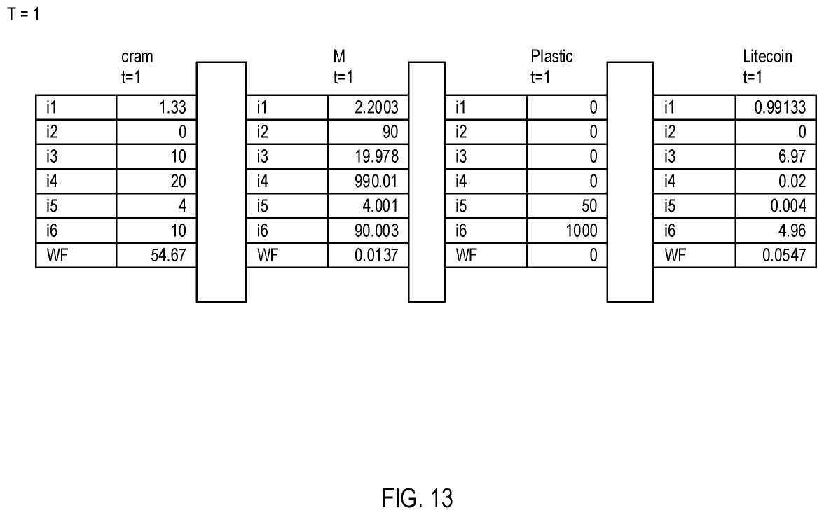

Referring now to FIG. 12B, after the various actions 1102 have occurred, the asset issuer computing device 704 then calculates the fee disbursement amongst the users and the asset issuer based on the relative CRAM ownership percentages. For example, the combined fee charged on all metal claim transactions at the first action time was 0.025 M and the combined fee charged on all Litecoin crypto chip transactions at the first action time was 0.1 LTC. Accordingly, each user and the asset issuer are given a proportional amount of each combined fees for each digital currency unit having charged fees. Once the fees have been applied, and the various account balances and attributes have been settled and updated accordingly, the time state may be changed from T=0 to T=1, and the block may confirmed with a hash function. FIG. 13 shows the various resulting account values once the fees have been applied and the various account balances and attributes have been settled and updated.

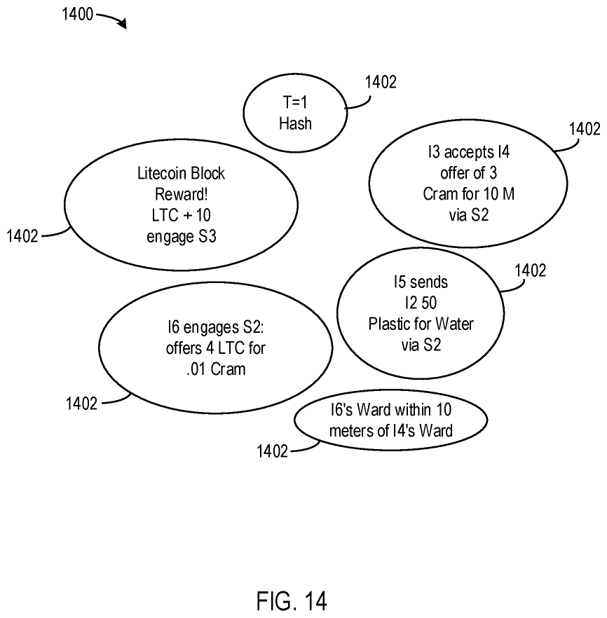

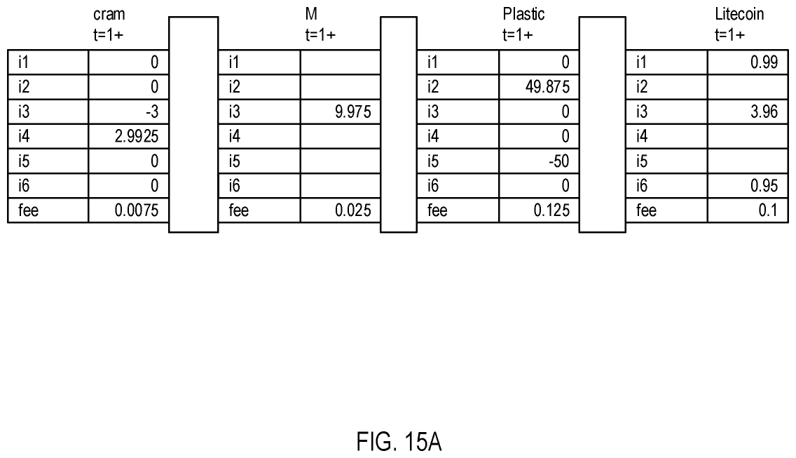

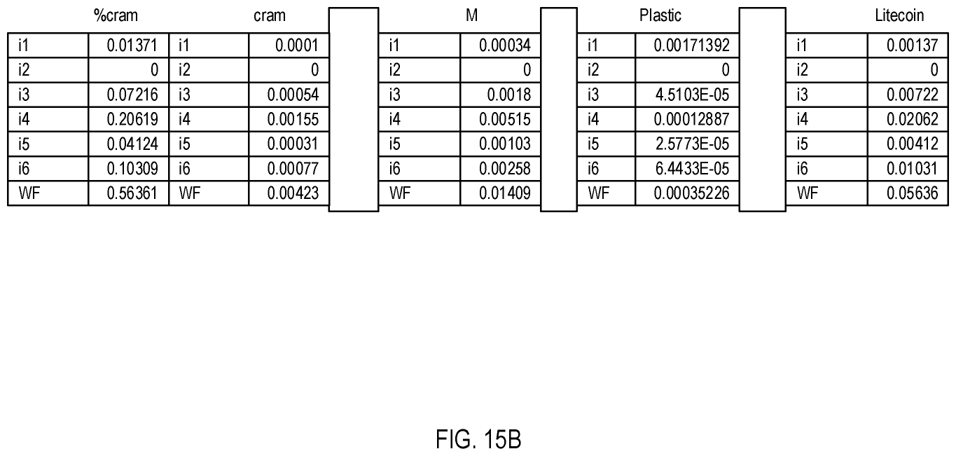

Referring now to FIG. 14, a state diagram 1400 is provided showing a plurality of actions 1402 configured to occur at a second action time (T=1). For example, at the second action time, another Litecoin Block Reward is distributed, as described above, with respect to the first action time. Additionally, at the second action time, user 3 (i3) accepts the offer from user 4 (i4) of 10 M for 3 CRAM via software process S2. Accordingly, as shown in FIG. 15A, the automated escrow contract or commodity delivery contract is configured to withdraw 3 CRAM from user 3 (i3) and deposit them into the account of user 4 (i4), and to deposit the frozen 10 M into the account of user 3 (i3). The asset issuer computing device 704 further charges a fee on this transaction between user 3 (i3) and user 4 (i4) (e.g., a 0.25% fee on both CRAM and M). Further, at the second action time, user 5 (i5) sends user 2 (i2) 50 plastic for water, via software process S2. Accordingly, as shown in FIG. 15A, the automated escrow contract or commodity delivery contract is configured to withdraw 50 plastic from user 5 (i5) and deposits the 50 plastic into the account of user 2 (i2). The asset issuer computing device 704 further charges a fee on this transaction (e.g., 0.25% fee on plastic). This transaction may further similarly be given a description of “water.” Additionally, at the second action time, user 6 (i6) offers 4 LTC for 0.01 CRAM, via software process S2. Accordingly, as shown in FIG. 15A, the automated escrow contract is configured to withdraw and freeze 4 LTC from the account of user 6 (i6). Further, at the second action time, a ward of user 6 (i6) may be within 10 meters of a ward of user 4 (i4), and software program S4 may be applied to perform a passive authentication process before providing a status of user 4 (i4) to user 6 (i6). For example, the authentication process and the corresponding providing of the status of user 4 (i4) to user 6 (i6) may be accomplished via a series of smart contracts conducted over the distributed ledger network 130 that allow for the passing of verified information between the two wards (i.e., the ward of user 6 (i6) and the ward of user 4 (i4)).

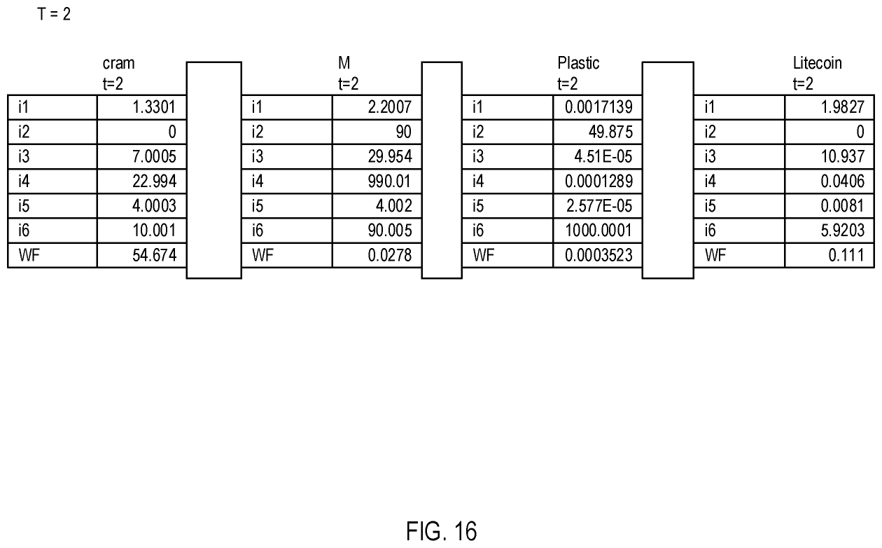

Referring now to FIG. 15B, after the various actions 1402 have occurred, the asset issuer computing device 704 then similarly calculates the fee disbursement amongst the users and the asset issuer based on the relative CRAM ownership percentages. For example, the combined fee charged on all metal claim transactions at the second action time was 0.025 M, the combined fee charged on all plastic at the second action time was 0.125 plastic, and the combined fee charged on all Litecoin crypto chip transactions at the second action time was 0.1 LTC. Accordingly, each user and the asset issuer are given a proportional amount of each combined fees for each digital currency unit having charged fees. Once the fees have been applied, and the various account balances and attributes have been settled and updated accordingly, the time state may be changed from T=1 to T=2, and the block may confirmed with a hash function. FIG. 16 shows the various resulting account values at the second action time once the fees have been applied and the various account balances and attributes have been settled and updated.

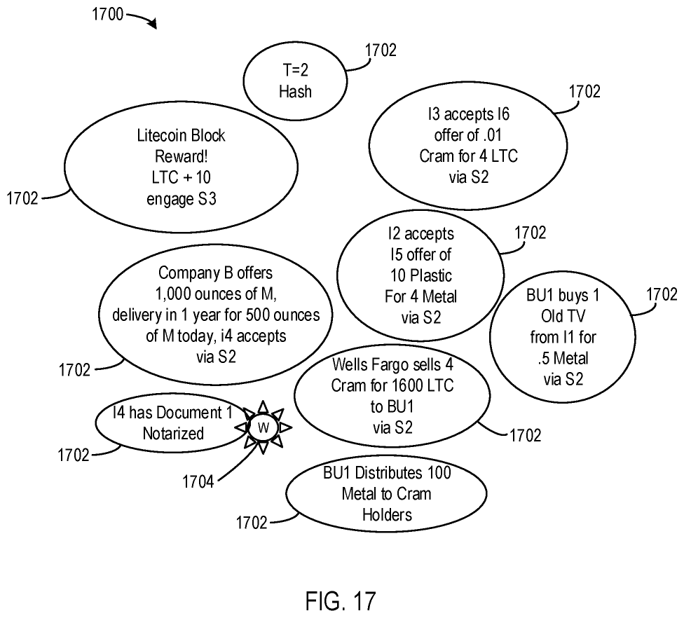

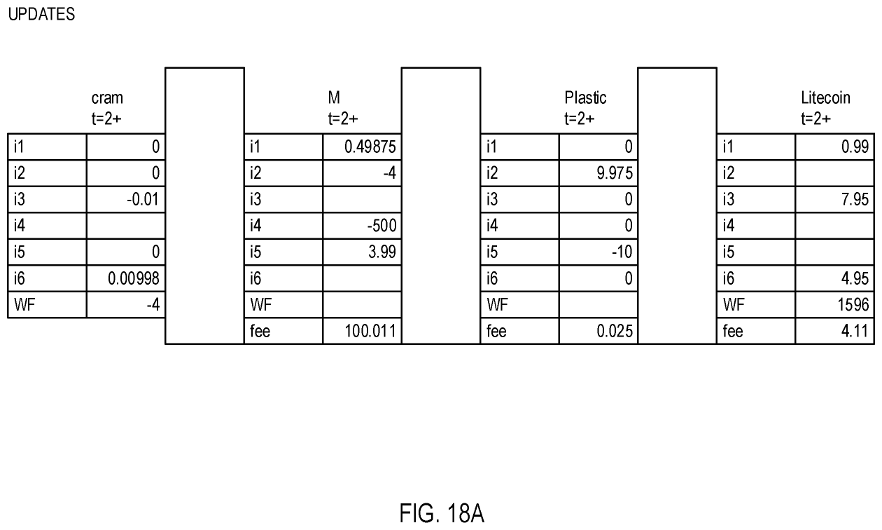

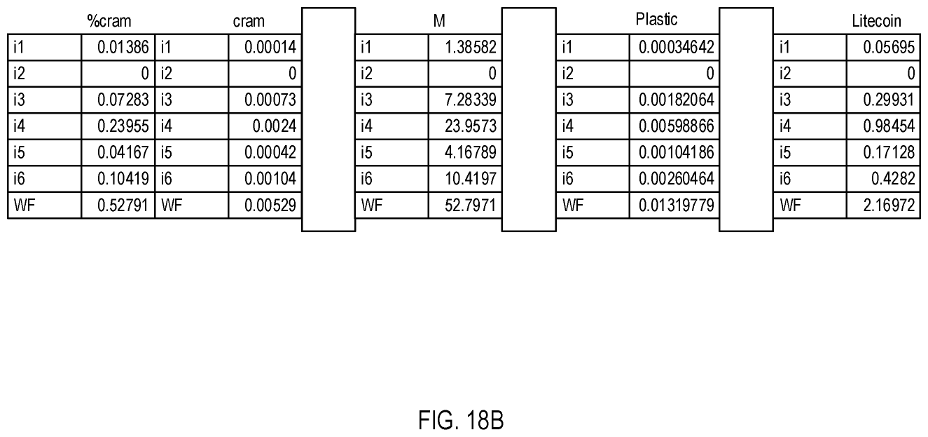

Referring now to FIG. 17, a state diagram 1700 is provided showing a plurality of actions 1702 configured to occur at a third action time (T=2). For example, at the third action time, another Litecoin Block Reward is distributed, as described above, with respect to the first and second actions time. Additionally, user 3 (i3) accepts the offer from user 6 (i6) of 0.01 CRAM for 4 LTC via software process S2. Accordingly, as shown in FIG. 18A, the automated escrow contract or commodity delivery contract is configured to withdraw 0.01 CRAM from user 3 (i3) and deposit them into the account of user 6 (i6), and to deposit the frozen 4 LTC into the account of user 3 (i3). The asset issuer computing device 704 further charges a fee on this transaction between user 3 (i3) and user 6 (i6) (e.g., a 0.25% fee on CRAM and 0.25% on LTC).

Further, a company (company B) having a node on the distributed ledger network 130 offers 1000 M in a year for 500 M today, via software process S2, and user 4 (i4) accepts. Accordingly, as shown in FIG. 18A, the automated escrow contract or commodity delivery contract is configured to withdraw 500 M from user 4 (i4) to be deposited into an account associated with company B. Company B will then be liable for, and have to pay user 4 (i4), 1000 M within a year to complete the contract. Additionally, user 2 (i2) accepts the offer of user 5 (i5) of 10 plastic for 4 M, via software process S2. Accordingly, the automated escrow contract or commodity delivery contract is configured to transfer 4 M from user 2 (i2) to user 5 (i5) and 10 plastic from user 5 (i5) to user 2 (i2). The asset issuer computing device 704 further charges a fee on this transaction (e.g., 0.25% fee on both the plastic and the M).

Additionally, at the third transaction time, the asset issuer computing device 704 sells 4 CRAM for 1600 LTC to a business unit computing system (BU1) having a node on the distributed ledger network 130, and the appropriate fees are assessed (e.g., 0.25% on CRAM and LTC). Additionally, BU1 buys an old TV from user 1 (i1) for 0.5 M, and the appropriate fees are assessed (e.g., 0.25% on M). Further, user 4 (i4) has a document (e.g., “document 1”) notarized by an agent 1704 of the asset issuer computing device 704, via software process S4. The agent 1704 may settle contracts per agreements, notarize documents, and have an employee ID hash that gets hashed into the transaction.

Additionally, the business unit computing system (BU1) distributed 100 M to CRAM holders. For example, in some instances, the business unit computing system may be configured to produce a “network profit” for the distributed ledger network 130. In some instances, the business unit computing system is configured to distribute network profits in a selective manner. For example, in some instances, if the business unit computing system is associated with a metal recycling group, the business unit associated with the business unit computing system may be configured to recycle metal and return a first portion of the recycled metal to CRAM holders (e.g., 25% of the net metal recycled) and a second portion of the recycled metal to members of the metal recycling group (e.g., 75% of the net metal recycled) via the distributed ledger network 130.

It will be appreciated that various other types of distributable assets may similarly be distributed in a selective manner over the distributed ledger network 130. For example, as described herein, smart contracts used with the network enable individuals to conduct various activities (e.g., smart contracts) and charge an associated fee for conducting the various activities. In some instances, the smart contracts may charge a business-unit-related fee that is above the standard transaction fee that is ultimately distributed to CRAM holders, thereby further increasing the demand to acquire and hold CRAM.

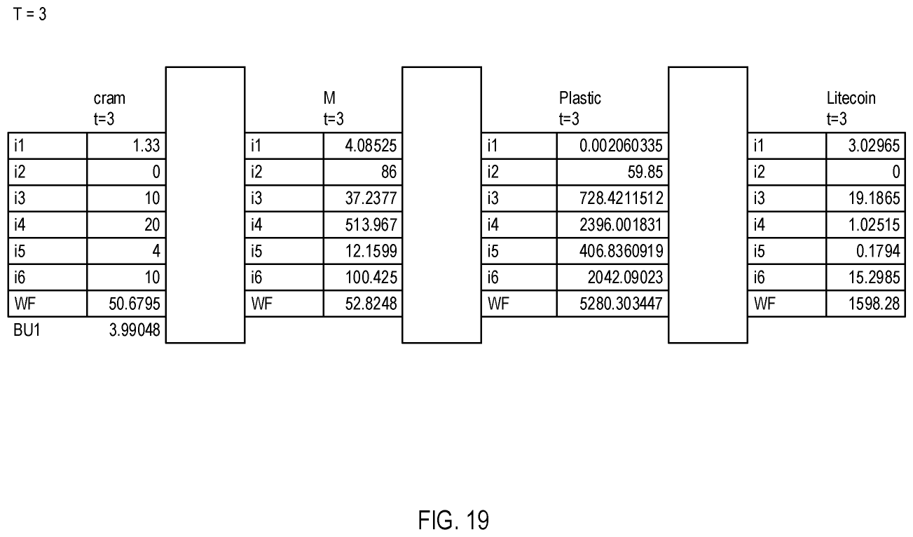

Referring now to FIG. 18B, after the various actions 1702 have occurred, the asset issuer computing device 704 then similarly calculates the fee disbursement amongst the users and the asset issuer based on the relative CRAM ownership percentages. For example, the combined fee charged on all metal claim transactions plus the distribution of metal claims to CRAM holders by BU1 at the third action time was 100.011 M, the combined fee charged on all plastic at the third action time was 0.025 plastic, and the combined fee charged on all Litecoin crypto chip transactions at the third action time was 4.11 LTC. Accordingly, each user and the asset issuer are given a proportional amount of each combined fees for each digital currency unit having charged fees (and CRAM distributions). Once the fees (and CRAM distributions) have been applied, and the various account balances and attributes have been settled and updated accordingly, the time state may be changed from T=2 to T=3, and the block may confirmed with a hash function. FIG. 19 shows the various resulting account values at the third action time once the fees have been applied and the various account balances and attributes have been settled and updated.

As can be seen in FIGS. 12A, 12B, 15A, 15B, 18A, and 18B, increasing transactions in multiple currencies within the distributed ledger network 130 results in multi-currency yields. Accordingly, members may be effectively incentivized both to obtain CRAM and to increase the number of transactions conducted using the distributed ledger network.

It should be appreciated that example process provided in FIGS. 9-19 is in no way meant to be limiting. For example, in some instances, the distributed ledger network 130 may be used in other ways and/or implement the use of various other types of digital currency units. For example, one use case of the distributed ledger network 130 may be a decentralized coded payWard contract. For example, given the fact that various digital currency units are configured to earn a percentage of yield from each block's pooled transaction fee, the distributed ledger network 130 can allow for owners of these digital currency units to send these certificates into a smart contract dictating that the yield generated while held in escrow is to be delivered to the contract's counterparty. Accordingly, once the yield generated from the digital currency units reaches a designated payment amount or a set length of time, the contract closes returning the digital currency units (and thus the associated future yields on those digital currency units after the contract has closed) back to the original owner. Summarizing the pay Ward contract utility, unrealized but expected yield on principle from future network transaction fees directed to the owner's digital currency units may now be pledged to another for a specific amount of time or yield without the original owner losing ownership of the principle digital currency units pledged for payment.

Another use case of the distributed ledger network 130 may be a proof of record. For example, in general, records are only viable based upon the acceptance and consensus of a community to recognize each record in whatever form it may manifest: title to a house or car, a social security number, a birth certificate or a disaster recovery plan.

Using the distributed ledger network 130, members can publish a hash of their vital records in order to time stamp the date and provide authenticity should these members need to prove their ownership or authenticity in the future. For example, multi-signature contracts of multiple users enable a community consensus to arise for Birth Certificates, School Transcripts and a variety of other individual and group records. Certificates of hashed records can be generated and owned by the members in their individual accounts, while the encrypted records may be stored on distributed databases (e.g., using the BitTorrent protocol integrated into the distributed ledger network 130). BitTorrent is a protocol for transferring large files, such as digital video files containing TV shows or video clips or digital audio files containing songs. Distributed ledger technology also offers unique advantages to encrypted file sharing. The alternatives will be analyzed for viability to ensure maximum privacy and utility.

Accordingly, in some instances, incorporation of proof of record software processes on the distributed ledger network 130 can effectively and efficiently replace functions requiring community consensus.

It will be appreciated that various other types of automated software processes may be incorporated into the distributed ledger network 130. For example, in some instances, automated software processes relating to RPA payment confirmation; GPS location beacons; personal address obfuscation; contractually-obligated asset yields as collateral for delivery; distributed vehicle routing networks; GPS land ledgers; distributed delegated credit allotments; distributed independent banker networks; cram-based knowledge delivery; preprogrammed automatic currency exchange smart contracts; machine learning deep fake advertising agents; metal currency verification and authentication smart contracts; My Momento; quantity time location exchange ration calculators; reverse distribution lotteries; dispersed audience; real-time cryptographically-secured voting; and/or a variety of other types of software processes, as desired for a given application.

The operations described in this specification can be implemented as operations performed by a data processing apparatus on data stored on one or more computer-readable storage devices or received from other sources.

The terms “data processing system” or “processor” encompass all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more subsystems, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, arrangements of the subject matter described in this specification can be carried out using a computer having a display device, e.g., a QLED (quantum dot display), OLED (organic light-emitting diode), or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, tactile input, or other biometric information. In addition, a computer can interact with a user by sending documents to and receiving documents from a device that is used by the user; for example, by sending web pages to a web browser on a user's client device in response to requests received from the web browser.

Arrangements of the subject matter described in this specification can be carried out using a computing system that includes a back-end component, e.g., as a data server, or that includes a middleware component, e.g., an application server, or that includes a front-end component, e.g., a client computer having a graphical user interface or a web browser through which a user can interact with an arrangement of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some arrangements, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific arrangement details, these should not be construed as limitations on the scope of the present disclosure or of what may be claimed, but rather as descriptions of features specific to particular arrangements of the present disclosure. Certain features that are described in this specification in the context of separate arrangements can also be carried out in combination or in a single arrangement. Conversely, various features that are described in the context of a single arrangement can also be carried out in multiple arrangements, separately, or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination.

Additionally, features described with respect to particular headings may be utilized with respect to and/or in combination with illustrative arrangement described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the arrangements described above should not be understood as requiring such separation in all arrangements, and it should be understood that the described program components and systems can generally be integrated together in a single software product or packaged into multiple software products embodied on tangible media.

Thus, particular arrangements of the subject matter have been described. Other arrangements are within the scope of the following claims. In some cases, the actions recited in the claims can be performed in a different order and still achieve desirable results. In addition, the processes depicted in the accompanying figures do not necessarily need the particular order shown, or sequential order, to achieve desirable results. In certain arrangements, multitasking and parallel processing may be advantageous.

1. A method for creating and performing an automated escrow contract on a distributed ledger network, the method comprising:
creating, by a first node associated with a first user of the distributed ledger network, the automated escrow contract on the distributed ledger network by providing contract information specifying an offer and at least one first key indicating ownership of an asset associated with the offer, wherein a value of the asset is identified by a unique tracking identifier, the unique tracking identifier comprising at least one second key associated with the unique tracking identifier;
accepting, by a second node associated with a second user of the distributed ledger network, the offer by providing a payment amount of a digital currency unit to the automated escrow contract on the distributed ledger network via an exchange of key pairs representative of the payment amount of the digital currency unit that prevents double spending of the payment amount of the digital currency unit;
confirming, by the second node, that the automated escrow contract has been completed by updating a completed state of the automated escrow contract from false to true;
responsive to the completed state being updated from false to true, automatically releasing, by the automated escrow contract, the payment amount of the digital currency unit from the automated escrow contract to the first user;
charging, by the automated escrow contract, a fee based on the payment amount of the digital currency unit;
sending, by the automated escrow contract, the fee to an asset issuer computing device;
determining, by the asset issuer computing device, an amount of promise-to-pay type digital currency owned by one or more users on the distributed ledger network; and
distributing, by a third node of the distributed ledger network and associated with the asset issuer computing device, the fee on a percentage basis to the one or more users on the distributed ledger network based on the amount of promise-to-pay type digital currency each user owns.

2. The method of claim 1, further comprising:
recording, by at least one of the first node or the second node, a transaction experience associated with the automated escrow contract within the automated escrow contract.

3. The method of claim 1, wherein the contract information is used in the creation of a Ricardian contract.

4. The method of claim 1, wherein the offer is for an exchange of the payment amount of the digital currency unit for a good or service to be provided by the first user to the second user outside of the distributed ledger network.

5. The method of claim 1, wherein the automated escrow contract is a commodity delivery contract and the contract information specifies a requirement for the inclusion of at least one of a contract ensurer, responsible for closing the commodity delivery contract, and a contract insurer, responsible for insuring a delivery of a commodity specified in the offer.

6-7. (canceled)

8. A system comprising:
a distributed ledger network;
at least one processing circuit configured to:
create, by a first node associated with a first user of the distributed ledger network, an automated escrow contract on the distributed ledger network by providing contract information specifying an offer and at least one first key indicating ownership of an asset associated with the offer, wherein a value of the asset is identified by a unique tracking identifier, the unique tracking identifier comprising at least one second key associated with the unique tracking identifier;
accept, by a second node associated with a second user of the distributed ledger network, the offer by providing a payment amount of a digital currency unit to the automated escrow contract on the distributed ledger network via an exchange of key pairs representative of the payment amount of the digital currency unit that prevents double spending of the payment amount of the digital currency unit;
confirm, by the second node, that the automated escrow contract has been completed by updating a completed state of the automated escrow contract from false to true;
responsive to the completed state being updated from false to true, automatically release, by the automated escrow contract, the payment amount of the digital currency unit from the automated escrow contract to the first user;
charge, by the automated escrow contract, a fee based on the payment amount of the digital currency unit;
send, by the automated escrow contract, the fee to an asset issuer computing device;
determine, by the asset issuer computing device, an amount of promise-to-pay type digital currency owned by one or more users on the distributed ledger network; and
distribute, by a third node of the distributed ledger network and associated with the asset computing device, the fee on a percentage basis to the one or more users on the distributed ledger network based on the amount of promise-to-pay type digital currency each user owns.

9. The system of claim 8, wherein the at least one processing circuit is further configured to:
record, by at least one of the first node or the second node, a transaction experience associated with the automated escrow contract within the automated escrow contract.

10. The system of claim 8, wherein the contract information is used in the creation of a Ricardian contract.

11. The system of claim 8, wherein the offer is for an exchange of the payment amount of the digital currency unit for a good or service to be provided by the first user to the second user outside of the distributed ledger network.

12. The system of claim 8, wherein the automated escrow contract is a commodity delivery contract and the contract information specifies a requirement for the inclusion of at least one of a contract ensurer, responsible for closing the commodity delivery contract, and a contract insurer, responsible for insuring a delivery of a commodity specified in the offer.

13-14. (canceled)

15. One or more computer-readable storage media having instructions stored thereon that, when executed by at least one processing circuit, cause the at least one processing circuit to:
create, by a first node associated with a first user of a distributed ledger network, an automated escrow contract on the distributed ledger network by providing contract information specifying an offer and at least one first key indicating ownership of an asset associated with the offer, wherein a value of the asset is identified by a unique tracking identifier, the unique tracking identifier comprising at least one second key associated with the unique tracking identifier;
accept, by a second node associated with a second user of the distributed ledger network, the offer by providing a payment amount of a digital currency unit to the automated escrow contract on the distributed ledger network via an exchange of key pairs representative of the payment amount of the digital currency unit that prevents double spending of the payment amount of the digital currency unit;
confirm, by the second node, that the automated escrow contract has been completed by updating a completed state of the automated escrow contract from false to true;
responsive to the completed state being updated from false to true, automatically release, by the automated escrow contract, the payment amount of the digital currency unit from the automated escrow contract to the first user;
charge, by the automated escrow contract, a fee based on the payment amount of the digital currency unit;
send, by the automated escrow contract, the fee to an asset issuer computing device;
determine, by the asset issuer computing device, an amount of promise-to-pay type digital currency owned by one or more users on the distributed ledger network; and
distribute, by a third node of the distributed ledger network and associated with the asset computing device, the fee on a percentage basis to the one or more users on the distributed ledger network based on the amount of promise-to-pay type digital currency each user owns.

16. The one or more computer-readable storage media of claim 15, having additional instructions stored thereon that, when executed by the at least one processing circuit, further cause the at least one processing circuit to:
record, by at least one of the first node or the second node, a transaction experience associated with the automated escrow contract within the automated escrow contract.

17. The one or more computer-readable storage media of claim 15, wherein the contract information is used in the creation of a Ricardian contract.

18. The one or more computer-readable storage media of claim 15, wherein the offer is for an exchange of the payment amount of the digital currency unit for a good or service to be provided by the first user to the second user outside of the distributed ledger network.

19. The one or more computer-readable storage media of claim 15, wherein the automated escrow contract is a commodity delivery contract and the contract information specifies a requirement for the inclusion of at least one of a contract ensurer, responsible for closing the commodity delivery contract, and a contract insurer, responsible for insuring a delivery of a commodity specified in the offer.

20. (canceled)

21. The method of claim 1, wherein the fee is distributed by the third node upon a pooled amount of transaction fees collected by the asset issuer computing device from multiple automated escrow contracts on the distributed ledger network reaching a threshold balance.
